(19) United States
(12) Patent Application Publication
(10) Pub. No.: US 2024/0193484 A1
(43) Pub. Date: Jun. 13, 2024

(54) DEVICE FOR GENERATING DATA MERGING RULE FOR MACHINE LEARNING MODEL, OPERATION METHOD AND PROGRAM FOR DEVICE FOR GENERATING DATA MERGING RULE, LEARNING DEVICE FOR MACHINE LEARNING MODEL, AND OPERATION METHOD AND PROGRAM FOR LEARNING DEVICE

(71) Applicant: FUJIFILM CORPORATION, Tokyo (JP)

(72) Inventors: Shotaro MISAWA, Tokyo (JP); Ryuji KANO, Tokyo (JP); Tomoko OHKUMA, Tokyo (JP); Tomoki TANIGUCHI, Tokyo (JP); Hirokazu YARIMIZU, Tokyo (JP); Kohei ONODA, Tokyo (JP)

(21) Appl. No.: 18/582,692

(22) Filed: Feb. 21, 2024

Related U.S. Application Data
(63) Continuation-in-part of application No. PCT/JP2022/031883, filed on Aug. 24, 2022.

(30) Foreign Application Priority Data
Aug. 25, 2021 (JP) 2021-137517

(51) Int. Cl. G06N 20/00

(52) U.S. Cl. CPC G06N 20/00

(57) ABSTRACT

There is provided a device for generating a data merging rule for a machine learning model, the device including: a processor, and a memory connected to or built in the processor, in which the processor is configured to execute specifying processing of specifying a combination of feature vectors that are included in a data set including a correct answer label and are allowed to be merged, and rule generation processing of generating a merging rule of the feature vectors based on a combination of the feature vectors that are allowed to be merged.

### CROSS-REFERENCE TO RELATED APPLICATIONS

This application is a continuation-in-part application of International Application No. PCT/JP2022/031883, filed on Aug. 24, 2022, which claims priority from Japanese Application No. 2021-137517, filed on Aug. 25, 2021. The entire disclosure of each of the above applications is incorporated herein by reference.

### BACKGROUND

### Technical Field

The present disclosure relates to a device for generating a data merging rule for a machine learning model, an operation method and a program for a device for generating a data merging rule, a learning device for a machine learning model, and an operation method and a program for a learning device.

### Related Art

In the medical field, a machine learning model that predicts a prognosis of a patient based on medical data of the patient has been developed. For example, JP2020-529057A discloses a machine learning model that predicts a medical event from medical data of a patient including symptoms, drugs, examination values, diagnosis, vital signs, and the like.

As information included in the medical data of the patient, a symptom of the patient is considered as an example. Generally, an item of the symptom of the medical data includes text information such as “cough”, “headache”, or “fever” input by a doctor. The text information is input to the machine learning model, for example, as a feature vector with a one-hot representation. The feature vector with the one-hot representation is a vector in which only one component is 1 and all other components are 0, for example, as in (1, 0, 0).

In a case where the text information is converted into the feature vector with the one-hot representation by focusing only on a difference in notation, a large number of feature vectors having the same or a similar meaning are generated. For example, in a case where there are variations in the notation such as “cough” and “Seki(cough)” or “high fever” and “fever” as patient's symptoms input by a doctor, the information may be represented as different feature vectors. Even in a case where the feature vectors having substantially the same or similar meaning are input to the machine learning model without any change, sufficient prediction accuracy cannot be often obtained.

Further, for example, as for the ages of the patients, it is expected that the prediction accuracy is improved by creating the feature vectors by grouping the patients, such as “20s”, rather than creating the feature vectors by distinguishing the patients for each age. However, in this case, a unit size of the grouping is large, and in a case where the group is formed with an excessively large unit size, the prediction accuracy is lowered.

In the related art, by merging the feature vectors having substantially the same or a similar meaning by a manual operation of a person, the number of dimensions of the feature vectors input to a machine learning model is reduced. However, merging the feature vectors by a manual operation of a person requires a significant amount of time and effort, and there is no guarantee that improvement in prediction accuracy can always be expected.

### SUMMARY

The present disclosure provides a device for generating a data merging rule for a machine learning model and a learning device for a machine learning model that can improve prediction accuracy of a machine learning model by reducing the number of dimensions of feature vectors by merging the feature vectors which are included in input data and are allowed to be merged, as compared with a case where the feature vectors are not merged and the number of dimensions of the feature vectors is not reduced.

According to a first aspect of the present disclosure, there is provided a device for generating a data merging rule for a machine learning model, the device including: a processor; and a memory connected to or built in the processor, in which the processor is configured to execute specifying processing of specifying a combination of feature vectors that are included in a data set including a correct answer label and are allowed to be merged, and rule generation processing of generating a merging rule of the feature vectors based on a combination of the feature vectors that are allowed to be merged.

According to a second aspect of the present disclosure, in the first aspect, in the specifying processing, the processor may be configured to create a frequency distribution of a correct answer label for each of the feature vectors included in the data set, and specify a combination of the feature vectors in which a similarity in the frequency distribution of the correct answer label is equal to or higher than a predetermined first threshold value, as the combination of the feature vectors that are allowed to be merged.

According to a third aspect of the present disclosure, in the second aspect, in the specifying processing, the processor may be configured to further create, for a combination specified as the combination of the feature vectors that are allowed to be merged, a frequency distribution in consideration of a combination of a plurality of items, and exclude the specified combination from the combinations of the feature vectors that are allowed to be merged in a case where a similarity in the frequency distribution in consideration of the combination of the items is lower than a predetermined second threshold value.

According to a fourth aspect of the present disclosure, in the first aspect, in the specifying processing, the processor may be configured to create, for each of the feature vectors included in the data set, a frequency distribution of a correct answer label in consideration of a combination of a plurality of items, and specify a combination of the feature vectors in which a similarity in the frequency distribution of the correct answer label is equal to or higher than a predetermined seventh threshold value, as the combination of the feature vectors that are allowed to be merged.

According to a fifth aspect of the present disclosure, in any one aspect of the first aspect to the fourth aspect, in the rule generation processing, the processor may be configured to end generation of the merging rule in a case where the number of combinations of the feature vectors that are included in the merging rule and are allowed to be merged is equal to or larger than a predetermined third threshold value.

According to a sixth aspect of the present disclosure, in the first aspect, in the specifying processing, the processor is configured to generate a provisional model in which the feature vectors included in the data set are used as inputs and train the provisional model, and select a combination of the feature vectors from the data set, and specify, as the combination of the feature vectors that are allowed to be merged, the selected combination of the feature vectors in a case where a change value of a prediction result of the provisional model in a case where the selected combination of the feature vectors is swapped is lower than a predetermined fourth threshold value.

According to a seventh aspect of the present disclosure, in the first aspect, in the specifying processing, the processor may be configured to generate a provisional model in which the feature vectors included in the data set are used as inputs and train the provisional model, and select a combination of the feature vectors from the data set, and specify, as the combination of the feature vectors that are allowed to be merged, the selected combination of the feature vectors in a case where a similarity in a prediction result of the provisional model in a case where the selected combination of the feature vectors is swapped is equal to or higher than a predetermined fourth similarity.

According to an eighth aspect of the present disclosure, in any one aspect of the first aspect to the seventh aspect, in the specifying processing, candidates of the feature vectors that are allowed to be merged may be determined based on at least one of an edit distance, a distribution representation, or related information of the feature vectors.

According to a ninth aspect of the present disclosure, in any one aspect of the first aspect to the eighth aspect, the processor may be configured to further execute display processing of displaying the combination of the feature vectors that are allowed to be merged on a display unit, and reception processing of receiving, from a user, whether or not to merge the combination of the feature vectors that are allowed to be merged.

Further, according to a tenth aspect of the present disclosure, there is provided a learning device that trains a machine learning model by using a training data set obtained by performing merging according to a merging rule generated by the data merging rule generation device according to the first aspect to the ninth aspect.

Further, according to an eleventh aspect of the present disclosure, there is provided a prediction device that causes a machine learning model to perform prediction by using, as an input, data obtained by performing merging according to the merging rule generated by the data merging rule generation device according to the first aspect to the ninth aspect.

Further, according to a twelfth aspect of the present disclosure, there is provided an operation method for a device for generating a data merging rule for a machine learning model, the method including: a step of specifying a combination of feature vectors that are included in a data set including a correct answer label and are allowed to be merged; and a step of generating a merging rule of the feature vectors based on a combination of the feature vectors that are allowed to be merged.

Further, according to a thirteenth aspect of the present disclosure, there is provided a program that generates a data merging rule for a machine learning model, the program causing a computer to execute a process including: a step of specifying a combination of feature vectors that are included in a data set including a correct answer label and are allowed to be merged; and a step of generating a merging rule of the feature vectors based on a combination of the feature vectors that are allowed to be merged.

According to a fourteenth aspect of the present disclosure, there is provided a learning device for a machine learning model, the device including: a processor; and a memory connected to or built in the processor, in which the machine learning model includes a merging layer that converts first feature vectors into second feature vectors and outputs the second feature vectors, and the processor is configured to execute training processing of training the machine learning model in response to an input of the second feature vector, and merge, in the training processing, the second feature vectors output from the merging layer by changing a conversion rule from the first feature vectors to the second feature vectors in the merging layer.

According to a fifteenth aspect of the present disclosure, in the fourteenth aspect, the processor may be configured to, in the training processing, change the conversion rule in the merging layer by using an algorithm in which a score is given based on a value of a loss function used for training the machine learning model.

According to a sixteenth aspect of the present disclosure, in the fifteenth aspect, the score of the algorithm may include the number of the second feature vectors to be merged in the merging layer.

According to a seventeenth aspect of the present disclosure, in the fifteenth aspect or the sixteenth aspect, an initial value of the score of the algorithm may be determined based on at least one of an edit distance, a distribution representation, or related information of the first feature vectors which are input to the merging layer.

According to an eighteenth aspect of the present disclosure, in the fourteenth aspect, the machine learning model may further include an embedding layer that outputs embedding vectors corresponding to the second feature vectors, and the processor may be configured to, in the training processing, make a combination of the similar embedding vectors more similar.

According to a nineteenth aspect of the present disclosure, in the eighteenth aspect, the processor may be configured to, in the training processing, introduce a term that makes the combination of the similar embedding vectors more similar, to a loss function used for training the machine learning model.

According to a twentieth aspect of the present disclosure, in the eighteenth aspect, the processor may be configured to, in the training processing, swap a combination of the embedding vectors having a similarity equal to or higher than a predetermined second similarity with a predetermined probability.

According to a twenty-first aspect of the present disclosure, in the eighteenth aspect, the processor may be configured to, in the training processing, add a correction value for making a combination of the embedding vectors more similar, to at least one of combinations of the embedding vectors having a similarity equal to or higher than a predetermined third similarity.

According to a twenty-second aspect of the present disclosure, in any one aspect of the eighteenth aspect to the twenty-first aspect, the processor may be configured to, in the training processing, merge combinations of the second feature vectors that correspond to combinations of the embedding vectors having a similarity equal to or higher than a predetermined first similarity.

According to a twenty-third aspect of the present disclosure, in any one aspect of the eighteenth aspect to the twenty-first aspect, the processor may be configured to, in the training processing, merge combinations of the second feature vectors that correspond to combinations of the embedding vectors in a case where a change value of a prediction result of the machine learning model in a case where the combination of the embedding vectors is swapped is lower than a predetermined seventh threshold value.

According to a twenty-fourth aspect of the present disclosure, in the eighteenth aspect, the processor may be configured to, in the training processing, merge combinations of the second feature vectors that correspond to combinations of the embedding vectors in a case where a similarity of a prediction result of the machine learning model in a case where the combination of the embedding vectors is swapped is equal to or higher than a predetermined fifth threshold value.

Further, according to a twenty-fifth aspect of the present disclosure, there is provided an operation method for a learning device for a machine learning model including a merging layer that converts first feature vectors into second feature vectors and outputs the second feature vectors, the method including: a step of training the machine learning model by using the second feature vectors, in which the step of training the machine learning model includes a step of merging the second feature vectors output from the merging layer by changing a conversion rule from the first feature vectors to the second feature vectors in the merging layer.

Further, according to a twenty-sixth aspect of the present disclosure, there is provided a program for training a machine learning model including a merging layer that converts first feature vectors into second feature vectors and outputs the second feature vectors, the program causing a computer to execute a process including: a step of training the machine learning model by using the second feature vectors, in which the step of training the machine learning model includes a step of merging the second feature vectors output from the merging layer by changing a conversion rule from the first feature vectors to the second feature vectors in the merging layer.

### BRIEF DESCRIPTION OF THE DRAWINGS

FIG. 1 is a diagram illustrating a schematic configuration of a hospitalization period prediction system according to an exemplary embodiment 1.

FIG. 2 is a block diagram illustrating a hardware configuration of a prediction server according to the exemplary embodiment 1.

FIG. 3 is a diagram illustrating a functional configuration of the prediction server according to the exemplary embodiment 1.

FIG. 4 is a diagram illustrating an example of a first training data set used in the exemplary embodiment 1.

FIG. 5 is a diagram illustrating an example of first medical data used in the exemplary embodiment 1.

FIG. 6 is a diagram illustrating an example of a frequency distribution of a correct answer label created in the exemplary embodiment 1.

FIG. 7 is a diagram illustrating an example of a feature vector merging rule generated in the exemplary embodiment 1.

FIG. 8 is a diagram illustrating an example of a second training data set generated in the exemplary embodiment 1.

FIG. 9 is a diagram illustrating an example of second medical data generated in the exemplary embodiment 1.

FIG. 10 is a flowchart illustrating an operation of the prediction server according to the exemplary embodiment 1 as a data merging rule generation device.

FIG. 11 is a diagram illustrating an example of a frequency distribution in consideration of a combination of items created in a modification example of the exemplary embodiment 1.

FIG. 12 is a diagram illustrating a functional configuration of the prediction server according to an exemplary embodiment 2.

FIG. 13 is a flowchart illustrating processing performed by a specifying unit of the prediction server according to the exemplary embodiment 2.

FIG. 14 is a diagram illustrating a detailed configuration of a provisional model generated in the exemplary embodiment 2.

FIG. 15 is a diagram illustrating an example of a pattern of a combination of feature vectors generated in the exemplary embodiment 2.

FIG. 16 is a diagram illustrating a functional configuration of the prediction server according to an exemplary embodiment 3.

FIG. 17 is a diagram illustrating an example of a training data set used in the exemplary embodiment 3.

FIG. 18 is a diagram illustrating a detailed configuration of a machine learning model according to the exemplary embodiment 3.

FIG. 19 is a diagram illustrating an operation in a merging layer and an embedding layer of the machine learning model according to the exemplary embodiment 3.

FIG. 20 is a flowchart illustrating training processing of a machine learning model that is performed by a training control unit of the prediction server according to the exemplary embodiment 3.

FIG. 21 is a diagram illustrating an example of a score table created in the exemplary embodiment 3.

FIG. 22 is a flowchart illustrating score calculation processing performed by a training control unit of the exemplary embodiment 3.

FIG. 23 is a diagram illustrating provisional merging of second feature vectors in a merging layer of the machine learning model according to the exemplary embodiment 3.

FIG. 24 is a diagram illustrating another example of the score table created in the exemplary embodiment 3.

FIG. 25 is a diagram illustrating an example of a score table recreated in the exemplary embodiment 3.

FIG. 26 is a diagram illustrating a functional configuration of the prediction server according to an exemplary embodiment 4.

FIG. 27 is a flowchart illustrating training processing of a machine learning model that is performed by a training control unit of the prediction server according to the exemplary embodiment 4.

FIG. 28 is a diagram illustrating a list of combinations of embedding vectors corresponding to combinations of second feature vectors in the exemplary embodiment 4.

FIG. 29 is a diagram illustrating merging of second feature vectors in a merging layer of the machine learning model according to the exemplary embodiment 4.

FIG. 30 is a diagram illustrating a functional configuration of the prediction server according to an exemplary embodiment 5.

FIG. 31 is a flowchart illustrating training processing of a machine learning model that is performed by a training control unit of the prediction server according to the exemplary embodiment 5.

FIG. 32 is a diagram illustrating a functional configuration of the prediction server according to an exemplary embodiment 6.

FIG. 33 is a flowchart illustrating training processing of a machine learning model that is performed by a training control unit of the prediction server according to the exemplary embodiment 6.

### DESCRIPTION

Hereinafter, in an exemplary embodiment of the present disclosure, an example in which a technical idea of the present disclosure is applied to a hospitalization period prediction system that predicts a hospitalization period of a patient based on medical data of the patient at a time of hospitalization admission will be described with reference to the accompanying drawings. Here, a scope to which the technical idea of the present disclosure can be applied is not limited thereto. Further, in addition to the disclosed exemplary embodiments, various forms that can be implemented by those skilled in the art are within the scope of the claims.

### Exemplary Embodiment 1

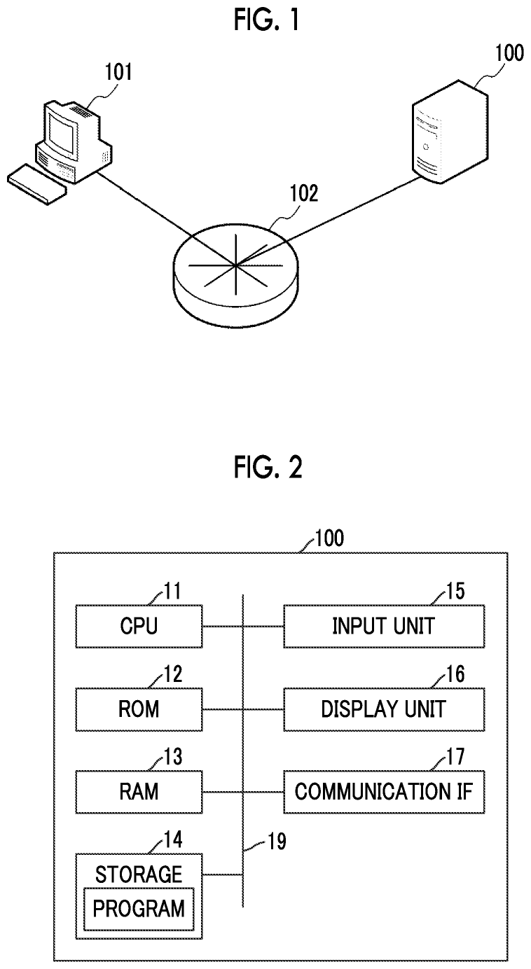

FIG. 1 is a diagram illustrating a schematic configuration of a hospitalization period prediction system according to an exemplary embodiment 1 of the present disclosure. The hospitalization period prediction system includes a prediction server 100, a user terminal 101, and a communication line 102 that connects the prediction server 100 and the user terminal 101 to each other for communication.

The prediction server 100 predicts a hospitalization period of a patient based on medical data of the patient that is transmitted from the user terminal 101 via the communication line 102. The prediction server 100 returns a predicted hospitalization period of the patient to the user terminal 101 via the communication line 102.

The user terminal 101 is a well-known personal computer. The communication line 102 is the Internet, an intranet, or the like. The communication line 102 may be a wired line or a wireless line. In addition, the communication line 102 may be a dedicated line or a public line.

FIG. 2 is a block diagram illustrating a hardware configuration of the prediction server 100. The prediction server 100 includes a central processing unit (CPU) 11, a read only memory (ROM) 12, a random access memory (RAM) 13, a storage 14, an input unit 15, a display unit 16, and a communication interface 17. The hardware components are communicably connected to each other via a bus 19.

The CPU 11 is a central arithmetic processing unit. The CPU 11 reads a program stored in the ROM 12 or the storage 14, and executes the program by using the RAM 13 as a work area. In the present exemplary embodiment 1, the ROM 12 or the storage 14 stores a program for predicting a hospitalization period of a patient based on medical data of the patient.

The ROM 12 stores various programs and various types of data. The RAM 13 as a work area temporarily stores the program or the data. The storage 14 is configured with a storage device such as a hard disk drive (HDD), a solid state disk (SSD), or a flash memory, and stores various programs including an operating system and various types of data.

The input unit 15 is configured with a mouse, a keyboard, and the like, and is used in a case where a user inputs data to the prediction server 100.

The display unit 16 is, for example, a liquid crystal display panel, and is used in a case where the prediction server 100 presents information to the user. Note that the display unit 16 and the input unit 15 may be implemented in common by adopting a touch-panel-type liquid crystal display panel.

The communication interface 17 is an interface that allows the prediction server 100 to perform communication with another device such as the user terminal 101. As a standard of the communication interface 17, for example, Ethernet (registered trademark), a fiber distributed data interface (FDDI), or Wi-Fi (registered trademark) can be adopted.

### (Functional Configuration of Prediction Server 100)

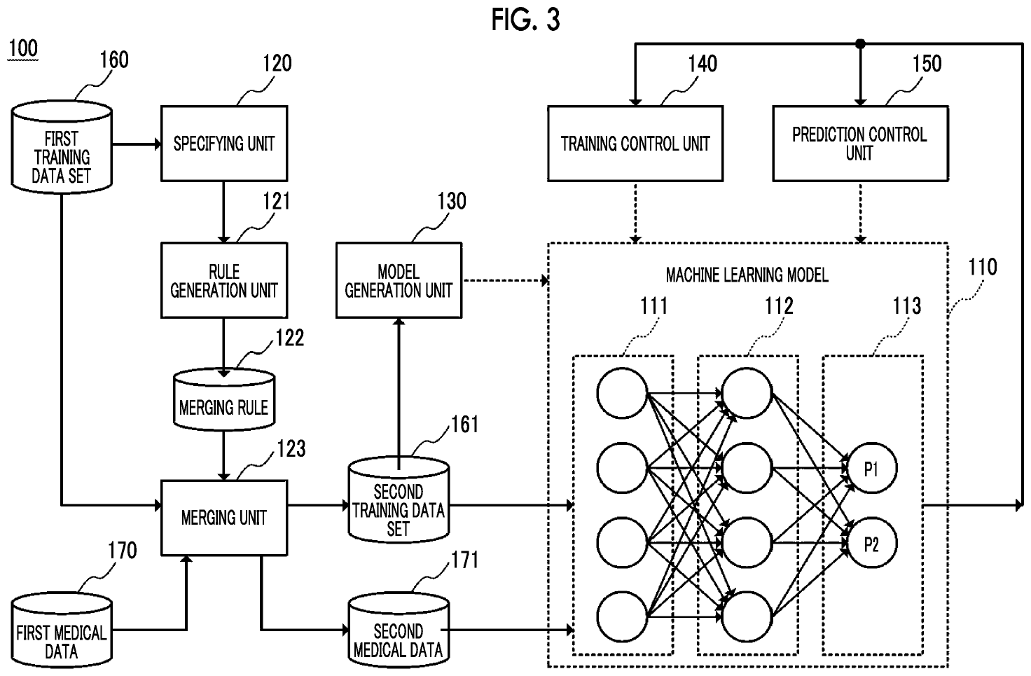

FIG. 3 is a diagram illustrating a functional configuration of the prediction server 100 according to the present exemplary embodiment 1. The prediction server 100 includes, as a functional configuration, a machine learning model 110, a specifying unit 120, a rule generation unit 121, a merging unit 123, a model generation unit 130, a training control unit 140, and a prediction control unit 150. These functional configurations are realized in a case where the CPU 11 of the prediction server 100 reads out a program stored in the ROM 12 or the storage 14 and executes the program.

A first training data set 160 and first medical data 170 are input to the prediction server 100. The first training data set 160 is a set of pieces of training data created from pieces of medical data of past inpatients, and is used in a training phase for training the machine learning model 110. The first medical data 170 is medical data of a patient whose hospitalization period is desired to be predicted, and is used in an operation phase in which the trained machine learning model 110 performs prediction.

The first training data set 160 is stored in the storage 14 or is provided from an external device (not illustrated) via the communication line 102. The first medical data 170 is provided from the user terminal 101 via the communication line 102.

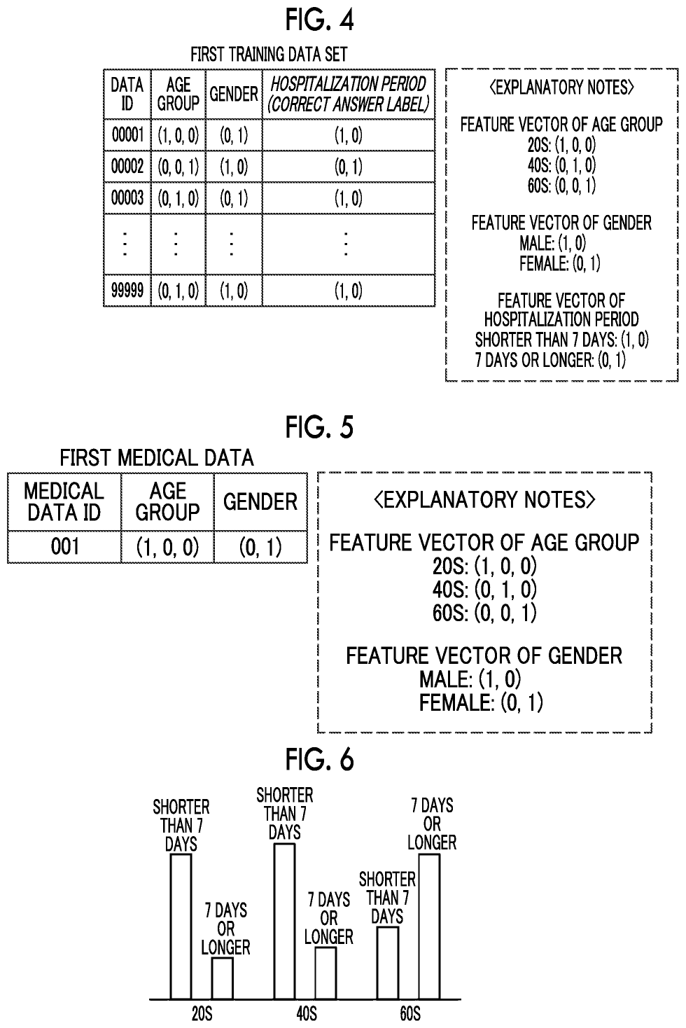

FIG. 4 is a diagram illustrating an example of the first training data set 160 used in the present exemplary embodiment 1. The first training data set 160 is a set of pieces of training data created from pieces of medical data of a plurality of past inpatients. The first training data set 160 includes 80% training data, 10% verification data, and 10% test data. Each of the pieces of training data includes a data identifier (ID), two items, and one correct answer label. The first item is an “age group” of the patient, the second item is a “gender” of the patient, and the correct answer label is a “hospitalization period” of the patient.

In the present exemplary embodiment 1, there are three types of “age groups” of patients, “20s”, “40s”, and “60s”, and feature vectors representing these types are defined as three-dimensional one-hot vectors. Specifically, the feature vector representing “20s” is (1, 0, 0), the feature vector representing “40s” is (0, 1, 0), and the feature vector representing “60s” is (0, 0, 1).

Further, the “gender” of the patient is two types of a “male” and a “female”, and feature vectors representing these types are defined as two-dimensional one-hot vectors. Specifically, the feature vector representing a “male” is (1, 0), and the feature vector representing a “female” is (0, 1).

In addition, the “hospitalization period” of the patient as a correct answer label is any one of “shorter than 7 days” or “7 days or longer”, and feature vectors representing these periods are defined as two-dimensional one-hot vectors. Specifically, the feature vector representing “shorter than 7 days” is (1, 0), and the feature vector representing “7 days or longer” is (0, 1).

For example, the training data of which the data ID in a first row of FIG. 4 is “00001” is data in which the age group is “20s”, the gender is “female”, and the hospitalization period of the patient is “shorter than 7 days”.

FIG. 5 is a diagram illustrating an example of the first medical data 170 used in the present exemplary embodiment 1. The first medical data 170 is medical data of a patient whose hospitalization period is desired to be predicted, and includes a medical data ID and two items. The two items have the same format as the items of the first training data set 160. That is, the first item is the “age group” of the patient, and the second item is the “gender” of the patient.

### (Specifying Unit 120)

Returning to FIG. 3, the specifying unit 120 specifies a combination of the feature vectors that are included in the first training data set 160 and are allowed to be merged. The combination of the feature vectors that are allowed to be merged is a combination of the feature vectors having the same or a similar meaning, and a combination of the feature vectors that provide the same or a similar prediction result in a case of being input to the machine learning model 110 to be described.

The specifying unit 120 creates a frequency distribution of the correct answer label for each feature vector of each item included in the first training data set 160 in order to specify a combination of the feature vectors that are allowed to be merged.

For example, for each feature vector of “20s”, “40s”, and “60s” in the item of “age group” included in the first training data set 160, a frequency distribution of the correct answer label is created, and a histogram of the frequency distribution is expressed as illustrated in FIG. 6.

Next, the specifying unit 120 specifies, as the combination of the feature vectors that are allowed to be merged, for each combination of the feature vectors considered in FIG. 6, that is, each of a combination of the feature vectors of “20s” and “40s”, a combination of the feature vectors of “40s” and “60s”, and a combination of the feature vectors of “60s” and “20s”, a combination in which a similarity in the frequency distribution is equal to or higher than a predetermined first threshold value. The similarity in the frequency distribution can be calculated using, for example, a scale such as Kullback-Leibler (KL) divergence or Jensen-Shannon (JS) divergence.

For example, in the example of FIG. 6, “shorter than 7 days” is relatively frequent in the hospitalization periods of “20s” and “40s”, and “7 days or longer” is relatively frequent in the hospitalization period of “60s”. Therefore, the similarity between “20s” and “40s” is high. Therefore, in FIG. 6, in a case where a condition that the similarity in the frequency distribution for the combination of the feature vectors of “20s” and “40s” is equal to or higher than the first threshold value is satisfied, the specifying unit 120 specifies, as the combination of the feature vectors that are allowed to be merged, the combination of the feature vectors of “20s” and “40s”.

### (Rule Generation Unit 121)

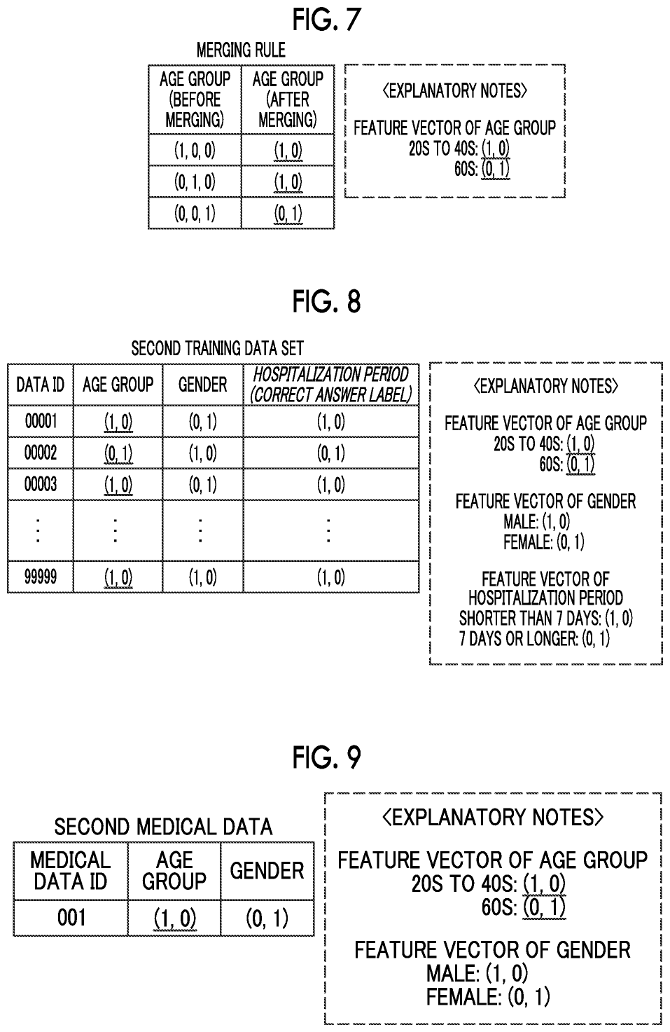

The rule generation unit 121 generates a feature vector merging rule 122 based on a combination of the feature vectors that is specified by the specifying unit 120 and are allowed to be merged. For example, in a case where the combination of the feature vectors of “20s” and “40s” in the item of “age group” is specified by the specifying unit 120 as the combination of the feature vectors that are allowed to be merged, the rule generation unit 121 generates a merging rule 122 as illustrated in FIG. 7. The rule generation unit 121 stores the generated merging rule 122 in, for example, the storage 14 in a readable manner.

### (Merging Unit 123)

The merging unit 123 reads out the merging rule 122 generated by the rule generation unit 121 from the storage 14. In addition, the merging unit 123 generates a second training data set 161 by merging the combination of the feature vectors that are included in the first training data set 160 and are allowed to be merged, based on the read merging rule 122. For example, the merging unit 123 generates the second training data set 161 as illustrated in FIG. 8 from the first training data set 160 as illustrated in FIG. 4, based on the merging rule 122 as illustrated in FIG. 7.

Here, a comparison between the first training data set 160 of FIG. 4 and the second training data set 161 of FIG. 8 will be made. In the first training data set 160 of FIG. 4, the feature vector of the item of “age group” is three-dimensional. On the other hand, in the second training data set 161 of FIG. 8, the feature vector of the item of “age group” is two-dimensional. This is because, in a process of generating the second training data set 161 from the first training data set 160, due to merging of the combination of the feature vectors of “20s” and “40s” in the item of “age group”, the dimensions of the feature vectors of the item of “age group” are reduced from three dimensions to two dimensions.

The second training data set 161 includes 80% training data, 10% verification data, and 10% test data. The training data is used in a case where the machine learning model 110 is trained.

In addition, the merging unit 123 generates second medical data 171 by merging the combination of the feature vectors that are included in the first medical data 170 and are allowed to be merged, based on the merging rule 122. For example, the merging unit 123 generates the second medical data 171 as illustrated in FIG. 9 from the first medical data 170 as illustrated in FIG. 5, based on the merging rule 122 as illustrated in FIG. 7.

Even in this case, in a process of generating the second medical data 171 from the first medical data 170, due to merging of the combination of the feature vectors of “20s” and “40s” in the item of “age group”, the dimensions of the feature vectors of the item of “age group” are reduced from three dimensions to two dimensions.

By using the second training data set 161 and the second medical data 171 in which the number of dimensions is reduced, as compared with a case where the first training data set 160 and the first medical data 170 are used, the prediction accuracy of the machine learning model 110 can be improved.

### (Model Generation Unit 130)

Returning to FIG. 3, the model generation unit 130 generates the machine learning model 110 based on the second training data set 161 generated by the merging unit 123.

### (Machine Learning Model 110)

The machine learning model 110 predicts whether the hospitalization period of the patient is “shorter than 7 days” or “7 days or longer”, in response to inputs of the feature vector representing the “age group” of the patient and the feature vector representing the “gender” of the patient. The machine learning model 110 is a deep learning model based on a neural network, and includes an input layer 111, an intermediate layer 112, and an output layer 113.

### (Input Layer 111)

The number of neurons included in the input layer 111 is equal to a sum of the number of dimensions of feature vectors of each item included in the second training data set 161. Specifically, in the second training data set 161, the number of dimensions of the feature vectors representing the “age group” is 2, and the number of dimensions of the feature vectors representing the “gender” is also 2. Therefore, the number of neurons included in the input layer 111 is 2+2=4.

For the number of neurons included in the intermediate layer 112, a special condition is not set. In addition, instead of a single intermediate layer, a plurality of intermediate layers may be provided. Each neuron included in the intermediate layer 112 adds a bias to a weighted sum of outputs of each neuron included in the input layer 111, and outputs a value obtained by applying an activation function to the added value. As the activation function, a Sigmoid function, a ReLU function, or the like can be used. Each neuron included in the input layer 111 is connected to all of the neurons included in the intermediate layer 112. That is, the input layer 111 and the intermediate layer 112 are fully connected.

### (Output Layer 113)

The number of neurons included in the output layer 113 is equal to the number of the correct answer labels included in the second training data set 161. In the second training data set 161, the correct answer labels are two types of “shorter than 7 days” and “7 days or longer”. Therefore, the output layer 113 includes two neurons. Each neuron included in the output layer 113 adds a bias to a weighted sum of outputs of each neuron included in the intermediate layer 112, and outputs a value obtained by applying an activation function to the added value. As the activation function, for example, a Softmax function can be used. The Softmax function is a function in which a sum of output values of each neuron included in the output layer 113 is 1. By using the Softmax function, an output value of each neuron included in the output layer 113 can be regarded as a probability.

One neuron of the output layer 113 outputs a probability P1 that the hospitalization period of the patient is “shorter than 7 days”. The other neuron of the output layer 113 outputs a probability P2 that the hospitalization period of the patient is “7 days or longer”. The intermediate layer 112 and the output layer 113 are fully connected.

### (Training Control Unit 140)

The training control unit 140 trains the machine learning model 110 such that the hospitalization period of the patient can be predicted, by using the training data included in the second training data set 161. In a training process of the machine learning model 110, a weight and a bias of each neuron included in the intermediate layer 112 and the output layer 113 of the machine learning model 110 are optimized.

Specifically, the training control unit 140 optimizes a weight and a bias of each neuron by an error backward propagation method using a loss function L defined according to the following equation based on a cross-entropy error.

$$L = - {\sum }_{n = 1}^{N} log {P}_{i} ( n )$$

Here, the above equation is based on a premise that the correct answer label is given in a form of a one-hot vector. In addition, Pi(n) is a probability that corresponds to a correct answer label of an n-th training data and is output from the output layer 113 of the machine learning model 110, and is any one of P1 or P2. Specifically, in a case where a correct answer label of an n-th training data is “shorter than 7 days”, Pi(n)=P1, and in a case where a correct answer label of an n-th training data is “7 days or longer”, Pi(n)=P2. In addition, N is the total number of the pieces of training data, and for example, N=100.

### (Prediction Control Unit 150)

The prediction control unit 150 inputs, to the machine learning model 110 obtained by performing training by the training control unit 140, that is, the input layer 111 of the trained machine learning model 110, the second medical data 171 whose hospitalization period of the patient is desired to be predicted.

The prediction control unit 150 displays the hospitalization period corresponding to a higher probability among the probabilities P1 and P2 output from the output layer 113 of the machine learning model 110, on the display unit 16 as the predicted hospitalization period. Specifically, in a case of P1>P2, the prediction control unit 150 causes the display unit 16 to display “shorter than 7 days”. On the other hand, in a case of P1<P2, the prediction control unit 150 causes the display unit 16 to display “7 days or longer”.

### (Operation of Prediction Server 100 as Data Merging Rule Generation Device)

Next, an operation of the prediction server 100 as a data merging rule generation device according to the present exemplary embodiment 1 will be described.

As described above, the prediction server 100 according to the present exemplary embodiment includes the specifying unit 120 and the rule generation unit 121 as a functional configuration. With these functional configurations, the prediction server 100 functions as a merging rule generation device for generating input data in which the number of dimensions is reduced by merging the combination of the feature vectors that are included in the input data and are allowed to be merged.

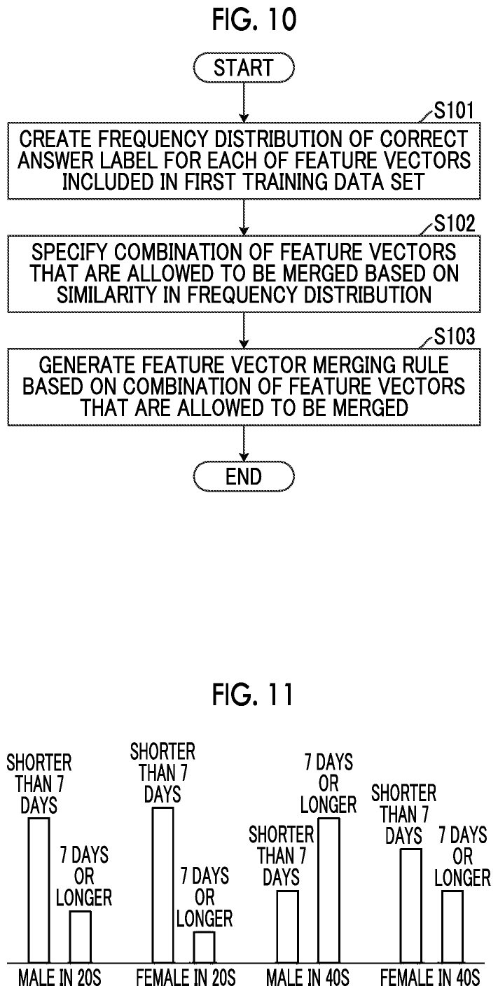

FIG. 10 is a flowchart illustrating an operation of the prediction server 100 as a data merging rule generation device. Specifically, these pieces of processing are executed by the specifying unit 120 and the rule generation unit 121 of the prediction server 100.

In step S101 of FIG. 10, the specifying unit 120 creates a frequency distribution of the correct answer label for each of feature vectors of each item included in the first training data set 160. For example, the frequency distribution of the correct answer label is as illustrated in FIG. 6 described above.

In step S102, the specifying unit 120 specifies, among combinations of feature vectors that can be considered, a combination of the feature vectors in which the similarity in the frequency distribution is equal to or higher than a predetermined first threshold value, as a combination of the feature vectors that are allowed to be merged. For example, in a case where the frequency distribution is as illustrated in FIG. 6, the specifying unit 120 specifies a combination of the feature vectors of “20s” and “40s” in the item of “age group”, as a combination of the feature vectors that are allowed to be merged.

In step S103, the rule generation unit 121 generates a feature vector merging rule 122 based on the combination of the feature vectors that are specified in step S102 and are allowed to be merged. For example, the feature vector merging rule 122 is as illustrated in FIG. 7 described above.

As described above, the data merging rule generation processing is completed. Thereafter, in a training phase in which the machine learning model 110 is trained, the merging unit 123 generates a second training data set 161 by merging, in each item included in the first training data set 160, the combination of the feature vectors that are allowed to be merged based on the merging rule 122 generated in step S103. For example, the second training data set 161 is as illustrated in FIG. 8.

Further, in an operation phase in which the machine learning model 110 performs prediction, the merging unit 123 generates second medical data 171 by merging, in each item included in the first medical data 170, the combination of the feature vectors that are allowed to be merged based on the feature vector merging rule 122 generated in step S103. For example, the second medical data 171 is as illustrated in FIG. 9 described above.

As described above, the prediction server 100 according to the present exemplary embodiment 1 functions as a data merging rule generation device for generating input data in which the number of dimensions is reduced by merging the combination of the feature vectors that are included in the input data and are allowed to be merged.

As described above, the combination of the feature vectors that are allowed to be merged is a combination of the feature vectors having the same or a similar meaning, and is more specifically, a combination of the feature vectors that provide the same or a similar prediction result in a case of being input to the machine learning model 110.

The data merging rule generation device specifies a combination of the feature vectors that are included in the first training data set 160 and are allowed to be merged, and generates a feature vector merging rule 122 based on the combination of the feature vectors that are allowed to be merged. Thereby, it is possible to improve the prediction accuracy of the machine learning model 110 as compared with a case where feature vectors are not merged and the number of dimensions is not reduced.

That is, as illustrated in the present example, even in a case where pieces of input data are different in the age groups of “20s” and “40s”, in a case where the pieces of input data are input to the machine learning model 110, the prediction results may be the same or similar. By merging the pieces of input data as in the present example, even in a case of pieces of input data having different age groups, such as pieces of input data in the age groups of “20s” and “40s”, the pieces of input data can be input to the machine learning model 110 as input data included in the same category having the same meaning. Thus, in the machine learning model 110, the number of pieces of input data included in the same category increases.

Thereby, in the training phase, pieces of the training data included in the same category are increased, and thus the training effect of the machine learning model 110 is improved. Therefore, it can be expected that the prediction accuracy of the machine learning model 110 in the operation phase is improved.

In the exemplary embodiment 1, the specifying unit 120 may further create a frequency distribution in consideration of a combination of the items, for the combination specified in step S102 of FIG. 10 as the combination of the feature vectors that are allowed to be merged, and in a case where a similarity in the frequency distribution in consideration of the combination of the items is lower than a predetermined second threshold value, exclude the combination from the combination of the feature vectors that are allowed to be merged.

Specifically, in step S102 of FIG. 10, for example, in a case where the combination of the feature vectors of “20s” and “40s” is specified as a combination of the feature vectors that are allowed to be merged, the specifying unit 120 may further create a frequency distribution in consideration of a combination of the “age group” and the “gender” as illustrated in FIG. 11.

In FIG. 11, the frequency distributions of “male in 20s” and “male in 40s” are not so similar. In addition, the frequency distributions of “female in 20s” and “female in 40s” are not so similar. This indicates that the similarity in the frequency distribution of the combination of the feature vectors of “20s” and “40s” in a case where the genders are not distinguished as illustrated in FIG. 6 and the similarity in the frequency distribution of the combination of the feature vectors of “20s” and “40s” in a case where the genders are distinguished as illustrated in FIG. 11 are different. Thus, it is suggested that “20s” and “40s” should not be merged in a case where the genders are distinguished.

In such a case, the specifying unit 120 may exclude the combination of the feature vectors of “20s” and “40s” that are once specified in step S102 of FIG. 10 as the combination of the feature vectors that are allowed to be merged, from the combinations of the feature vectors that are allowed to be merged.

In the exemplary embodiment 1, the combination of the feature vectors that are allowed to be merged for each single item is specified based on the similarity in the frequency distribution of the correct answer label of the combination of the feature vectors for each single item. Thereafter, the specified combination is excluded from the combinations of the feature vectors that are allowed to be merged based on the similarity in the frequency distribution of the correct answer label of the combination of the plurality of items. On the other hand, a method of specifying the combination of the feature vectors that are allowed to be merged for the combination of the plurality of items is not limited thereto.

The combination of the feature vectors in which the similarity in the frequency distribution of the correct answer label of the combination of the plurality of items is equal to or higher than a predetermined seventh threshold value may be specified as the combination of the feature vectors that are allowed to be merged. For example, instead of the frequency distribution of the correct answer label of only the “gender” in FIG. 6, the frequency distributions of the correct answer labels of “male in 20s”, “female in 20s”, “male in 40s”, and “female in 40s” obtained by combining the “gender” and the “age group” may be created. In a case where the similarity in the frequency distributions of “male in 20s” and “male in 40s” and similarity in the frequency distributions of “female in 20s” and “female in 40s” are equal to or higher than the seventh threshold value, “20s” and “40s” may be specified as a combination of the feature vectors that are allowed to be merged. In the present example, the “symptom”, the “age group”, and the “gender” are exemplified as the items. On the other hand, the present invention is not particularly limited thereto. Any item can be used as long as the item can be stored as medical data, and information such as “disease” or “medical department” is included.

Further, in the exemplary embodiment 1, in step S103 of FIG. 10, the rule generation unit 121 may end generation of the merging rule 122 at a stage in which the number of the combinations of the feature vectors that are included in the merging rule 122 and are allowed to be merged is equal to or larger than a predetermined third threshold value. By appropriately determining the third threshold value, it is possible to adjust the extent to which the combinations of the feature vectors are merged. In step S103 of FIG. 10, the rule generation unit 121 may end generation of the merging rule 122 at a stage in which the total number of the feature vectors to be reduced by performing merging using the merging rule 122 is equal to or larger than the predetermined third threshold value. For example, in a case where a combination of an item A, an item B, and an item C and a combination of an item D and an item E are included in the combinations of the feature vectors that are allowed to be merged, since the total number of the feature vectors to be reduced by performing merging based on the merging rule 122 is 3, the rule generation unit 121 determines whether or not the total number 3 is equal to or larger than the third threshold value. Further, as a priority for specifying the combination of the feature vectors, methods such as, selecting in descending order of value, weighting the one that has larger value and selecting in random, or selecting in random, may be adopted.

Further, in the embodiment 1, the age groups such as “20s” and “40s” are described as an example of the items to be merged. On the other hand, for example, text strings including a word representing a symptom of the patient, such as “cough” or “Seki (cough)” or “high fever” or “fever”, may be used. The “cough” and the “Seki (cough)” have the same meaning, and the only difference is whether the words are written in kanji or hiragana. In addition, “high fever” and “fever” are also similar. Therefore, the feature vectors of these items can be a combination that are allowed to be merged.

Further, in the exemplary embodiment 1, in a case where the specifying unit 120 specifies the combination of the feature vectors that are allowed to be merged in step S102 of FIG. 10, candidates for the combination of the feature vectors that are allowed to be merged may be narrowed down based on an edit distance, a distribution representation, related information, or the like of items represented by the feature vectors.

In the above example, the age groups such as “20s” and “40s” are exemplified as items for merging. On the other hand, in a case where items for merging are text strings, the edit distance is defined as the minimum number of procedures required to transform one text string into the other text string by insertion, deletion, or replacement of one text. It can be said that the edit distance between a plurality of text strings is shorter as the number of procedures required for transformation is smaller. A fact that the edit distance between the text strings is short means that the text strings are likely to be similar in meaning. Therefore, the specifying unit 120 can narrow down candidates for the combination of the feature vectors that are allowed to be merged, based on the edit distance.

The distribution representation is a technique of representing a word with a high-dimensional real number vector. In a case where words have close meanings, the words have close vector values. In a case where the items for merging are words with the distribution representation, the specifying unit 120 can narrow down candidates for the combination of the feature vectors that are allowed to be merged by specifying words having similar meanings based on the distribution representation. In addition, the related information is information indicating relevance of the meanings of targets for merging. The specifying unit 120 can narrow down candidates for the combination of the feature vectors that are allowed to be merged, based on the related information.

Further, in the exemplary embodiment 1, the specifying unit 120 may present, to the user, a list of the combinations of the feature vectors that are specified in step S102 of FIG. 10 and are allowed to be merged, by displaying the list on the display unit 16. The rule generation unit 121 may receive information indicating whether or not to merge each combination of the feature vectors displayed on the display unit 16 from the user via the input unit 15, and create a merging rule 122 based on a reception result.

In addition, the prediction server 100 according to the present exemplary embodiment 1 also functions as a learning device that performs training of the machine learning model by using the training data set that is merged according to the merging rule generated by the data merging rule generation device according to the present disclosure.

Further, the prediction server 100 according to the present exemplary embodiment 1 also functions as a prediction device that causes the machine learning model to perform prediction in response to an input of data that is merged according to the merging rule generated by the data merging rule generation device according to the present disclosure.

### Exemplary Embodiment 2

Next, the prediction server 200 according to an exemplary embodiment 2 of the present disclosure will be described. Note that, in the following description, components that are the same as or similar to those in the exemplary embodiment 1 are denoted by the same reference numerals and a detailed description of the components will be omitted.

### (Functional Configuration of Prediction Server 200)

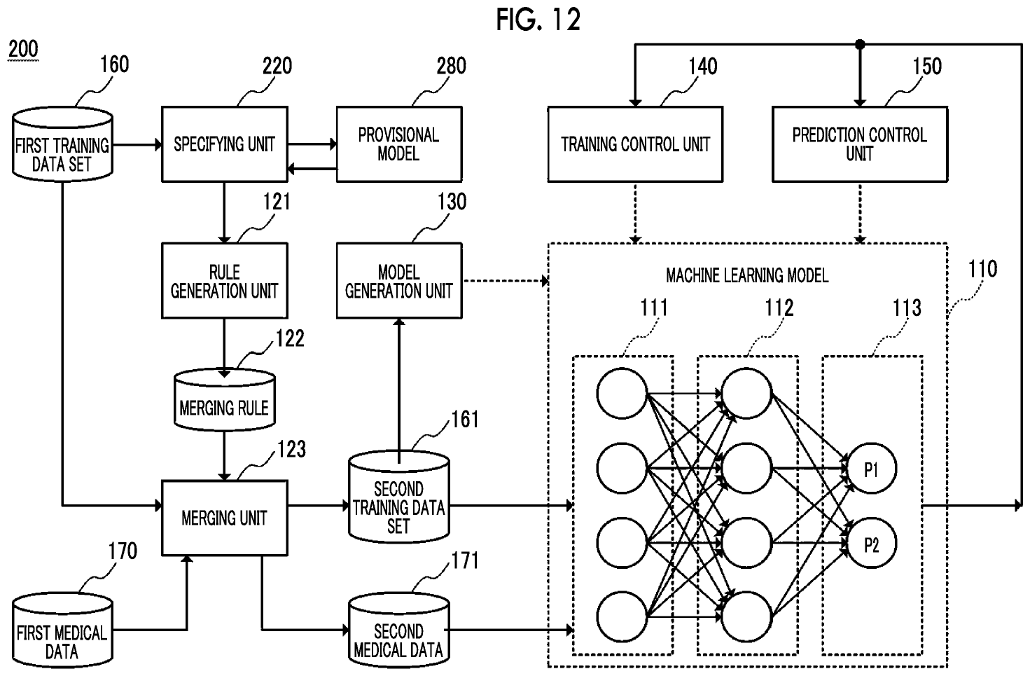

FIG. 12 is a diagram illustrating a functional configuration of the prediction server 200 according to the present exemplary embodiment 2. In the prediction server 200, the specifying unit 120 included in the exemplary embodiment 1 is replaced with the specifying unit 220. The specifying unit 220 generates a provisional model 280.

### (Processing Performed by Specifying Unit 220)

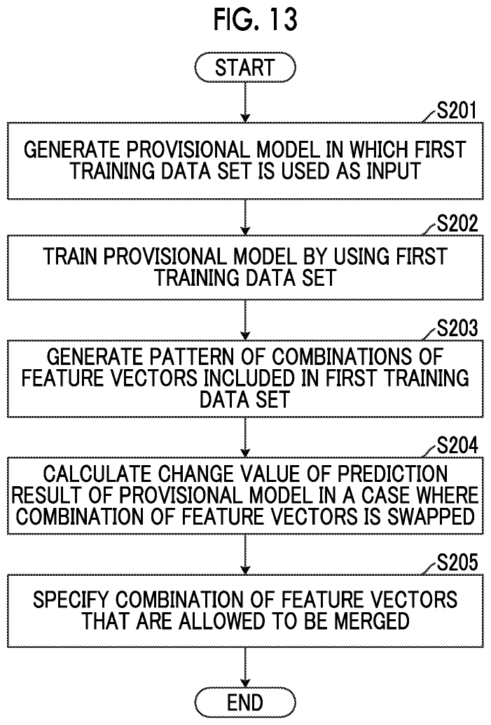

FIG. 13 is a flowchart illustrating processing performed by the specifying unit 220 of the prediction server 200 according to the present exemplary embodiment 2. At a start of the flowchart in FIG. 13, the first training data set 160 is divided into 80% training data, 10% verification data, and 10% test data.

In step S201 of FIG. 13, the specifying unit 220 generates the provisional model 280 in which the feature vectors included in the first training data set 160 are used as inputs.

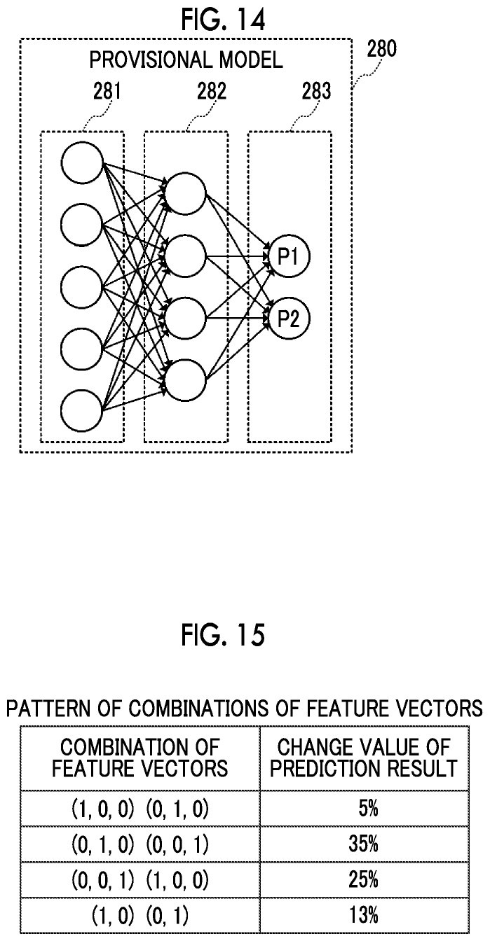

FIG. 14 is a diagram illustrating a detailed configuration of the provisional model 280. The provisional model 280 has a configuration similar to the configuration of the machine learning model 110, and includes an input layer 281, an intermediate layer 282, and an output layer 283. The configurations and the connection relationship of the intermediate layer 282 and the output layer 283 of the provisional model 280 are the same as the configurations and the connection relationship of the intermediate layer 112 and the output layer 113 of the machine learning model 110.

The number of neurons included in the input layer 281 of the provisional model 280 is equal to a sum of the number of dimensions of feature vectors of each item included in the first training data set 160. Specifically, in the first training data set 160 of FIG. 4, the number of dimensions of the feature vectors representing the “age group” is 3, and the number of dimensions of the feature vectors representing the “gender” is 2. Therefore, the number of neurons included in the input layer 281 is 3+2=5.

In step S202, the specifying unit 220 trains the provisional model 280 by using the training data included in the first training data set 160. Specifically, the specifying unit 220 optimizes a weight and a bias of each of neurons included in the intermediate layer 282 and the output layer 283 of the provisional model 280 by an error backward propagation method using a loss function L based on the cross-entropy error described in the exemplary embodiment 1.

In step S203, the specifying unit 220 lists the combinations of the feature vectors in each item included in the first training data set 160, and generates a pattern of the combinations of the feature vectors as illustrated in a left column of FIG. 15.

In step S204, the specifying unit 220 sequentially selects the combinations of the feature vectors one by one from the patterns of FIG. 15, and calculates a change value (change rate) of a prediction result of the provisional model 280 according to the following equation in a case where the selected combination of the feature vectors is swapped. A right column of FIG. 15 is a change value of a prediction result calculated for each of the combinations of the feature vectors.

$$change value of prediction result = \frac{1}{M} {\sum }_{m = 1}^{M} \vert {P}_{1} ( m ) - {P}_{1} \_swap ( m ) \vert$$

Here, in the above equation, P1(m) is a probability that the hospitalization period is “shorter than 7 days” in a case where m-th verification data is input to the provisional model 280 without swapping the selected combination of the feature vectors. In addition, P1_swap(m) is a probability that the hospitalization period is “shorter than 7 days” in a case where m-th verification data is input to the provisional model 280 while swapping the selected combination of the feature vectors. In addition, M is the total number of pieces of verification data.

Instead of the above equation, the change value of the prediction result may be calculated according to the following equation.

$$change value of prediction result = \frac{1}{M} {\sum }_{m = 1}^{M} \vert {P}_{2} ( m ) - {P}_{2} \_swap ( m ) \vert$$

Here, in the above equation, P2(m) is a probability that the hospitalization period is “7 days or longer” in a case where m-th verification data is input to the provisional model 280 without swapping the selected combination of the feature vectors. In addition, P2_swap(m) is a probability that the hospitalization period is “7 days or longer” in a case where m-th verification data is input to the provisional model 280 while swapping the selected combination of the feature vectors. In addition, M is the total number of pieces of verification data.

In step S205, the specifying unit 220 specifies, in the patterns illustrated in FIG. 15, as the combination of the feature vectors that are allowed to be merged, a combination of the feature vectors in which the change value of the prediction result is lower than a predetermined fourth threshold value. For example, in a case where the fourth threshold value=10%, the specifying unit 220 specifies, as the combination of the feature vectors that are allowed to be merged, a combination of the feature vectors of “20s” and “40s”.

As described above, the processing performed by the specifying unit 220 is completed. The operation of the prediction server 200 after the combinations of the feature vectors that are allowed to be merged are specified by the specifying unit 220 is the same as the operation in the exemplary embodiment 1.

As described above, the specifying unit 220 of the prediction server 200 according to the present exemplary embodiment 2 generates and trains the provisional model 280 in which the feature vectors included in the first training data set 160 are used as inputs. The specifying unit 220 selects a combination of the feature vectors from the first training data set 160, and in a case where the change value of the prediction result of the provisional model 280 in a case where the selected combination of the feature vectors is swapped is lower than the predetermined fourth threshold value, specifies the combination of the feature vectors, as a combination of the feature vectors that are allowed to be merged.

By the above-described characteristics, in the prediction server 200 according to the present exemplary embodiment 2, in a case where an input is input to the provisional model 280 having a configuration similar to the configuration of the machine learning model 110, merging of the combination of the feature vectors is performed while confirming that the same or a similar prediction result is obtained. Thereby, it is possible to more reliably improve the prediction accuracy of the machine learning model 110.

In the exemplary embodiment 2, in a case where the specifying unit 220 selects the combinations of the feature vectors one by one in step S204 of FIG. 13 and tries to swap the combinations of the feature vectors, the combinations of the feature vectors that are to be swapped may be narrowed down based on an edit distance, a distribution representation, related information, or the like of the feature vectors.

Further, in the exemplary embodiment 2, the specifying unit 220 may cause the display unit 16 to display, on the display unit 16, the list of the combinations of the feature vectors that are specified in step S205 of FIG. 13 and are allowed to be merged, in ascending order of the change values of the prediction results. The rule generation unit 121 may receive information indicating whether or not to merge each combination of the feature vectors displayed on the display unit 16 from the user via the input unit 15, and generate a merging rule 122 based on a reception result.

### Exemplary Embodiment 3

Next, a prediction server 300 according to an exemplary embodiment 3 of the present disclosure will be described. In the exemplary embodiments 1 and 2, merging of the feature vectors is performed before training of the machine learning model 110. On the other hand, in the present exemplary embodiment 3, merging of the feature vectors is performed in a process of training the machine learning model.

### (Functional Configuration of Prediction Server 300)

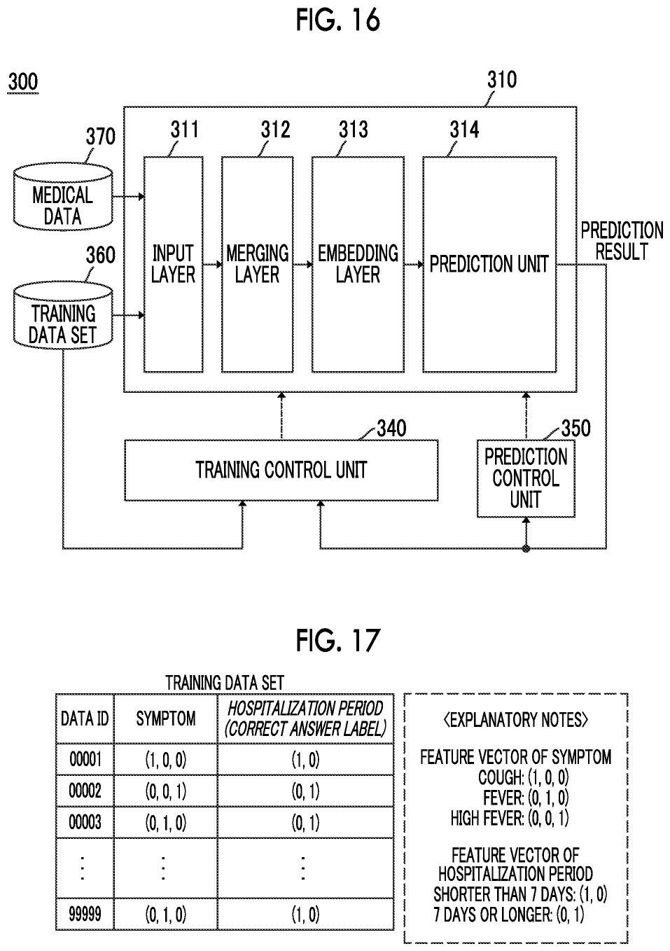

FIG. 16 is a diagram illustrating a functional configuration of the prediction server 300 according to the present exemplary embodiment 3. The prediction server 300 includes, as a functional configuration, a machine learning model 310, a training control unit 340, and a prediction control unit 350. These functional configurations are realized in a case where the CPU 11 of the prediction server 300 reads out a program stored in the ROM 12 or the storage 14 and executes the program.

A training data set 360 and medical data 370 are input to the prediction server 300. In a training phase in which the machine learning model 310 is trained, a training data set 360 created from the pieces of medical data of past inpatients is input. The training data set 360 is stored in the storage 14 or is provided from an external device (not illustrated) via the communication line 102. On the other hand, in an operation phase in which the trained machine learning model 310 performs prediction, medical data 370 of the patient whose hospitalization period is desired to be predicted is input. The medical data 370 is provided from the user terminal 101 via the communication line 102.

FIG. 17 is a diagram illustrating an example of the training data set 360 used in the present exemplary embodiment 3. The training data set 360 is a set of pieces of training data created from pieces of medical data of a plurality of past inpatients. The training data includes a data ID, an item of “symptom” of a patient, and “hospitalization period” as a correct answer label.

In the present exemplary embodiment 3, there are three types of “symptom” of a patient, “cough”, “fever”, and “high fever”, and first feature vectors representing these types are defined as three-dimensional one-hot vectors. Specifically, the first feature vector representing “cough” is (1, 0, 0), the first feature vector representing “fever” is (0, 1, 0), and the first feature vector representing “high fever” is (0, 0, 1).

In addition, the hospitalization period as a correct answer label is any one of “shorter than 7 days” or “7 days or longer”, and feature vectors representing these periods are defined as two-dimensional one-hot vectors. Specifically, the feature vector representing “shorter than 7 days” is (1, 0), and the feature vector representing “7 days or longer” is (0, 1). For example, the training data in which the data ID in a first row of FIG. 17 is “00001” indicates that the hospitalization period of the patient whose symptom at a time of hospitalization admission is “cough”=(1, 0, 0) is “shorter than 7 days”.

The training data set 360 includes 80% training data, 10% verification data, and 10% test data. The training data is used in a case where the machine learning model 310 is trained.

### (Machine Learning Model 310)

Returning to FIG. 16, the machine learning model 310 is a deep learning model based on a neural network, and includes an input layer 311, a merging layer 312, an embedding layer 313, and a prediction unit 314.

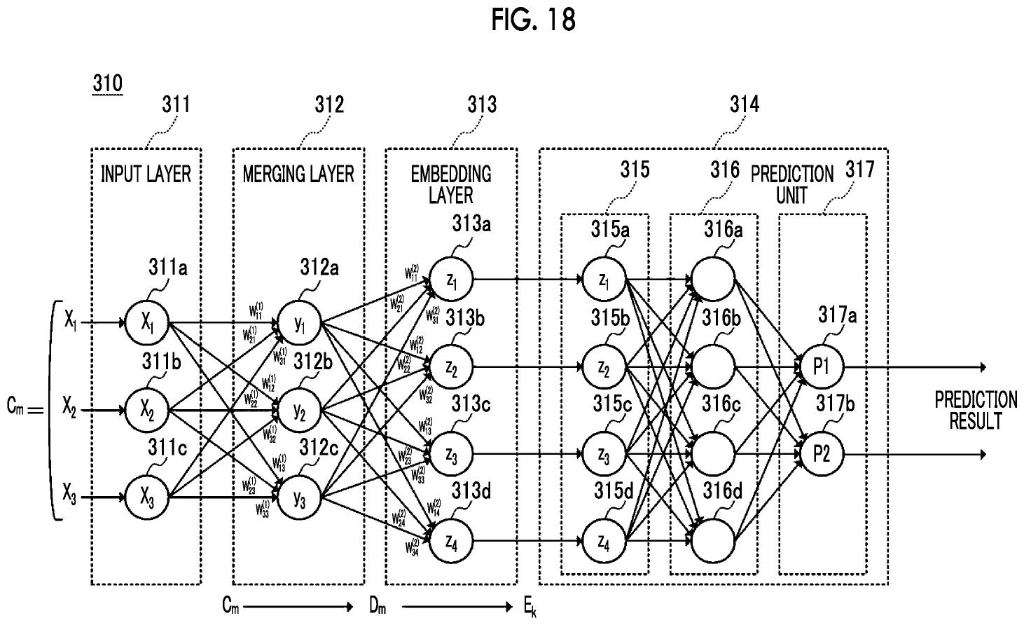

FIG. 18 is a diagram illustrating a detailed configuration of the machine learning model 310. The first feature vectors representing the “symptom” of the patient are input to the machine learning model 310. Hereinafter, the first feature vectors are expressed as Cₘ=(x₁, x₂, x₃)=(δ₁ₘ, δ₂ₘ, δ₃ₘ). Here, a subscript m=1, 2, 3, and δ is Kronecker's delta. Specifically, C₁=(1, 0, 0), C₂=(0, 1, 0), and C₃=(0, 0, 1).

### (Input Layer 311)

The input layer 311 outputs the input first feature vectors Cₘ=(x₁, x₂, x₃) without any change. Specifically, the input layer 311 includes three neurons 311a, 311b, and 311c. Each of the elements x₁, x₂, and x₃ of the first feature vectors Cₘ is input to each of the neurons 311a, 311b, and 311c. Each of the neurons 311a, 311b, and 311c outputs each of the elements x₁, x₂, and x₃ of the input first feature vectors Cₘ without any change.

The reason why the number of the neurons included in the input layer 311 is 3 is that the number of dimensions of the first feature vectors Cₘ considered in the present exemplary embodiment 3 is 3. In general, the input layer 311 includes neurons of which the number is equal to the number of dimensions of the first feature vectors Cₘ.

### (Merging Layer 312)

The merging layer 312 converts the first feature vectors Cₘ output from the input layer 311 into the second feature vectors Dₘ and outputs the second feature vectors Dₘ. Hereinafter, the second feature vectors are expressed as Dₘ=(y₁, y₂, y₃)=(δ₁ₘ, δ₂ₘ, δ₃ₘ). Here, a subscript m=1, 2, 3, and δ is Kronecker's delta. Specifically, D₁=(1, 0, 0), D₂=(0, 1, 0), and D₃=(0, 0, 1).

As described above, C₁=D₁=(1, 0, 0), C₂=D₂=(0, 1, 0), and C₃=D₃=(0, 0, 1). Therefore, a set {Cₘ} of the first feature vectors is equal to a set {Dₘ} of the second feature vectors. In other words, the merging layer 312 functions as a conversion table from the first feature vectors Cₘ to the second feature vectors Dₘ.

The merging layer 312 includes three neurons 312a, 312b, and 312c. In general, the merging layer 312 includes neurons of which the number is equal to the number of dimensions of the first feature vectors Cₘ.

Each of the neuron 312a, 312b, and 312c of the merging layer 312 outputs a weighted sum of the outputs x₁, x₂, and x₃ of each of the neurons 311a, 311b, and 311c of the input layer 311. Therefore, the outputs y₁, y₂, and y₃ of each of the neurons 312a, 312b, and 311c of the merging layer 312 can be written as follows using weights w⁽¹⁾₁₁ to w⁽¹⁾₃₃.

y₁=x₁·w⁽¹⁾₁₁+x₂·w⁽¹⁾₂₁+x₃·w⁽¹⁾₃₁

y₂=x₁·w⁽¹⁾₁₂+x₂·w⁽¹⁾₂₂+x₃·w⁽¹⁾₃₂

y₃=x₁·w⁽¹⁾₁₃+x₂·w⁽¹⁾₂₃+x₃·w⁽¹⁾₃₃

The above operation performed in the merging layer 312 can be written in a form of a matrix operation as follows.

Dₘ=CₘW⁽¹⁾

Here, in the above equation, Dₘ=(y₁, y₂, y₃) are the second feature vectors output from the merging layer 312, and Cₘ=(x₁, x₂, x₃) are the first feature vectors input to the merging layer 312. Further, the matrix W⁽¹⁾ is defined according to the following equation.

W⁽¹⁾=(w⁽¹⁾ᵢⱼ)

Here, subscripts i and j=1, 2, and 3.

Focusing on the function of the merging layer 312 as a conversion table, the second feature vectors Dₘ=(y₁, y₂, y₃) output from the merging layer 312 are expressed by D₁=C₁=(1, 0, 0), D₂=C₂=(0, 1, 0), or D₃=C₃=(0, 0, 1).

Further, in an initial state before the machine learning model 310 is trained, the merging layer 312 converts the first feature vectors Cₘ input from the input layer 311 into the second feature vectors Dₘ having the same value, in other words, the input is set to be output without any change, and outputs the second feature vectors Dₘ. That is, it is set that y₁=x₁, y₂=x₂, and y₃=x₃.

Therefore, in an initial state before training of the machine learning model 310, the matrix W⁽¹⁾ of the merging layer 312 is a unit matrix as follows.

W⁽¹⁾=(w⁽¹⁾ᵢⱼ)=(δᵢⱼ)

Here, subscripts i and j=1, 2, and 3.

Further, as will be described below, in a process of training the machine learning model 310, the weight of the matrix W⁽¹⁾ of the merging layer 312 is also changed. This means that the conversion rule from the first feature vectors Cₘ to the second feature vectors Dₘ in the merging layer 312 is changed. Specifically, merging of a plurality of second feature vectors Dₘ is performed. Thereby, the conversion rule is optimized such that the prediction accuracy of the machine learning model 310 is improved.

### (Embedding Layer 313)

The embedding layer 313 outputs embedding vectors Eₖ corresponding to the second feature vectors Dₘ output from the merging layer 312.

Specifically, the embedding layer 313 includes four neurons 313a, 313b, 313c, and 313d. The number of neurons included in the embedding layer 313 is not necessarily four. The number of neurons included in the embedding layer 313 may be 2, 3, or 5 or more. Usually, the number of neurons included in the embedding layer 313 is approximately 10 times to 1000 times the number of dimensions of the first feature vectors Cₘ.

Each of the neuron 313a, 313b, 313c, and 313d of the embedding layer 313 outputs a weighted sum of the outputs y₁, y₂, and y₃ of each of the neurons 312a, 312b, and 312c of the merging layer 312. Therefore, the outputs z₁, z₂, z₃, and z₄ of each of the neurons 313a, 313b, 313c, and 313d of the embedding layer 313 can be written as follows using the weights w⁽²⁾₁₁ to w⁽²⁾₃₄.

z₁=y₁·w⁽²⁾₁₁+y₂·w⁽²⁾₂₁+y₃·w⁽²⁾₃₁

z₂=y₁·w⁽²⁾₁₂+y₂·w⁽²⁾₂₂+y₃·w⁽²⁾₃₂

z₃=y₁·w⁽²⁾₁₃+y₂·w⁽²⁾₂₃+y₃·w⁽²⁾₃₃

z₄=y₁·w⁽²⁾₁₃+y₂·w⁽²⁾₂₃+y₃·w⁽²⁾₃₃

The above operation performed in the embedding layer 313 can be written in a form of a matrix operation as follows.

Eₖ=YₘW⁽²⁾

Here, in the above equation, Eₖ=(z₁, z₂, z₃, z₄) are embedding vectors output from the embedding layer 313, and Dₘ=(y₁, y₂, y₃) are the second feature vectors output from the merging layer 312. Further, the matrix W⁽²⁾ is defined according to the following equation.

W⁽²⁾=(w⁽²⁾ᵢⱼ)

Here, a subscript i=1, 2, 3, and a subscript j=1, 2, 3, and 4.

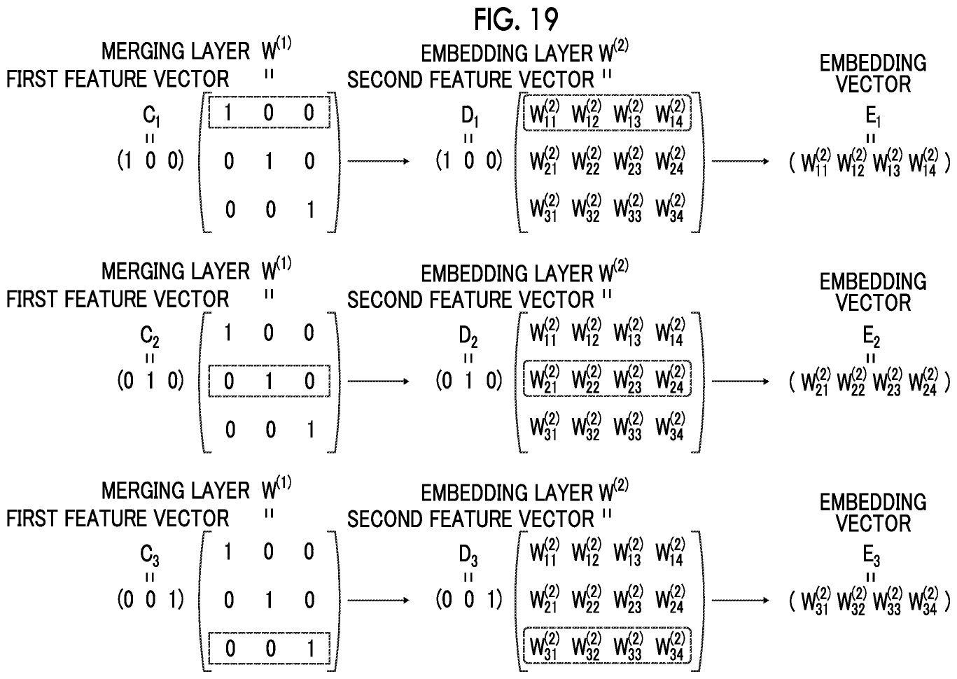

The above results are summarized as follows. In the initial state before the machine learning model 310 is trained, the operations performed in the merging layer 312 and the embedding layer 313 can be summarized as follows. FIG. 19 is also referred to. Further, in the following, “cough”, “fever”, and “high fever” are considered as examples of candidates to be merged.

In a case where the first feature vector C₁=(1, 0, 0) representing “cough” is input to the merging layer 312, the merging layer 312 converts the first feature vector into the second feature vector D₁=(1, 0, 0) having the same content and outputs the second feature vector. In a case where the second feature vector D₁=(1, 0, 0) is input to the embedding layer 313, the embedding layer 313 outputs an embedding vector E₁=(w⁽²⁾₁₁, w⁽²⁾₁₂, w⁽²⁾₁₃, w⁽²⁾₁₄) corresponding to the second feature vector.

In a case where the first feature vector C₂=(0, 1, 0) representing “fever” is input to the merging layer 312, the merging layer 312 converts the first feature vector into the second feature vector D₂=(0, 1, 0) having the same content and outputs the second feature vector. In a case where the second feature vector D₂=(0, 1, 0) is input to the embedding layer 313, the embedding layer 313 outputs an embedding vector E₂=(w⁽²⁾₂₁, w⁽²⁾₂₂, w⁽²⁾₂₃, w⁽²⁾₂₄) corresponding to the second feature vector.

In a case where the first feature vector C₃=(0, 0, 1) representing “high fever” is input to the merging layer 312, the merging layer 312 converts the first feature vector into the second feature vector D₃=(0, 0, 1) having the same content and outputs the second feature vector. In a case where the second feature vector D₃=(0, 0, 1) is input to the embedding layer 313, the embedding layer 313 outputs an embedding vector E₃=(w⁽²⁾₃₁, w⁽²⁾₃₂, w⁽²⁾₃₃, w⁽²⁾₃₄) corresponding to the second feature vector.

From the above results, it can be interpreted that the second feature vector D₁ is associated with the embedding vector E₁. Similarly, it can be interpreted that the second feature vector D₂ is associated with the embedding vector E₂ and the second feature vector D₃ is associated with the embedding vector E₃.

### (Prediction Unit 314)

Returning to FIG. 18, the prediction unit 314 predicts the hospitalization period of the patient in response to inputs of the embedding vectors Eₖ output from the embedding layer 313, in other words, the outputs z₁, z₂, z₃, and z₄ of each of the neurons 313a, 313b, 313c, and 313d of the embedding layer 313. Specifically, the prediction unit 314 includes an input layer 315, an intermediate layer 316, and an output layer 317.

### (Input Layer 315)

The input layer 315 includes four neurons 315a, 315b, 315c, and 315d. Each of the neurons 315a, 315b, 315c, and 315d transmits the outputs z₁, z₂, z₃, and z₄ of each of the neurons 313a, 313b, 313c, and 313d of the embedding layer 313 to the intermediate layer 316 without any change. In general, the input layer 315 includes the same number of neurons as the number of the neurons included in the embedding layer 313.

### (Intermediate Layer 316)

The intermediate layer 316 includes four neurons 316a, 316b, 316c, and 316d. Each of the neurons 316a, 316b, 316c, and 316d of the intermediate layer 316 adds a bias to the weighted sum of the outputs of each of the neurons 315a, 315b, 315c, and 315d of the input layer 315, and outputs a value obtained by applying an activation function to the added value. As the activation function, a Sigmoid function, a ReLU function, or the like can be used. The input layer 315 and the intermediate layer 316 are fully connected.

The number of neurons included in the intermediate layer 316 is not limited to four. The number of neurons included in the intermediate layer 316 may be 2 or 3, or may be 5 or more. In addition, instead of a single intermediate layer, a plurality of intermediate layers may be provided.

### (Output Layer 317)

The output layer 317 includes two neurons 317a and 317b. Each of the neurons 317a and 317b of the output layer 317 adds a bias to the weighted sum of the outputs of each of the neurons 316a, 316b, 316c, and 316d of the intermediate layer 316, and outputs a value obtained by applying an activation function to the added value. As the activation function, a Softmax function can be used. Thereby, the upper neuron 317a outputs a probability P1 that the hospitalization period of the patient is “shorter than 7 days”. The lower neuron 317b outputs a probability P2 that the hospitalization period of the patient is “7 days or longer”. The intermediate layer 316 and the output layer 317 are fully connected.

The reason why the number of neurons included in the output layer 317 is two is that there are two types of correct answer labels, “shorter than 7 days” and “7 days or longer”. In general, the output layer 317 includes neurons of which the number is equal to the types of the correct answer labels.

Further, as will be described later, in a process of training the machine learning model 310, a weight and a bias of each of the neurons included in the intermediate layer 316 and the output layer 317 of the prediction unit 314 are optimized.

### (Training Control Unit 340)

Returning to FIG. 16, the training control unit 340 trains the machine learning model 310 such that the hospitalization period of the patient can be predicted, by using the training data included in the training data set 360 described above. In a training process of the machine learning model 310, a weight and a bias of each of the neurons included in the embedding layer 313 and the prediction unit 314 of the machine learning model 310 are optimized.

Further, in a process of training the machine learning model 310, by changing the conversion rule from the first feature vectors Cₘ to the second feature vectors Dₘ in the merging layer 312, the training control unit 340 merges the second feature vectors Dₘ output from the merging layer 312.

Specifically, by changing the conversion rule from the first feature vectors Cₘ to the second feature vectors Dₘ in the merging layer 312 by using an algorithm in which a score is given based on a value of a loss function used for training the machine learning model 310, the training control unit 340 merges the second feature vectors Dₘ output from the merging layer 312. Thereby, the same effect as in the case of reducing the number of dimensions by merging the first feature vectors Cₘ generated from the medical data of the patient can be obtained.

### (Prediction Control Unit 350)

The prediction control unit 350 inputs the medical data 370 of the patient whose hospitalization period is desired to be predicted, to the input layer 311 of the machine learning model 310 after training, that is, the trained machine learning model 310. The medical data 370 of the patient is provided from the user terminal 101 via the communication line 102.

The prediction control unit 350 displays the hospitalization period corresponding to a higher probability among the probabilities P1 and P2 output from the output layer 317 of the prediction unit 314 of the machine learning model 310, on the display unit 16 as the predicted hospitalization period. Specifically, in a case of P1>P2, the prediction control unit 350 causes the display unit 16 to display “shorter than 7 days”. On the other hand, in a case of P1<P2, the prediction control unit 350 causes the display unit 16 to display “7 days or longer”.

### (Operation of Prediction Server 300 in Training of Machine Learning Model 310)

Next, an operation of the prediction server 300 according to the present exemplary embodiment 3 in training of the machine learning model 310 will be described.

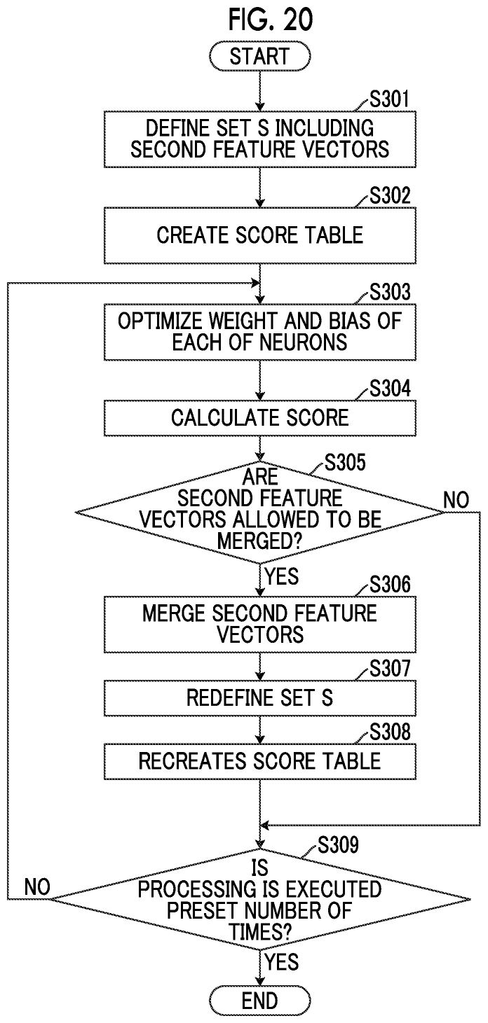

FIG. 20 is a flowchart illustrating training processing of the machine learning model 310 executed by the training control unit 340 of the prediction server 300.

In step S301 of FIG. 20, the training control unit 340 defines a set S including all the second feature vectors. In the present exemplary embodiment 3, the second feature vectors are three types of D₁, D₂, and D₃. Therefore, the set S={D₁, D₂, D₃} including all the second feature vectors is defined.

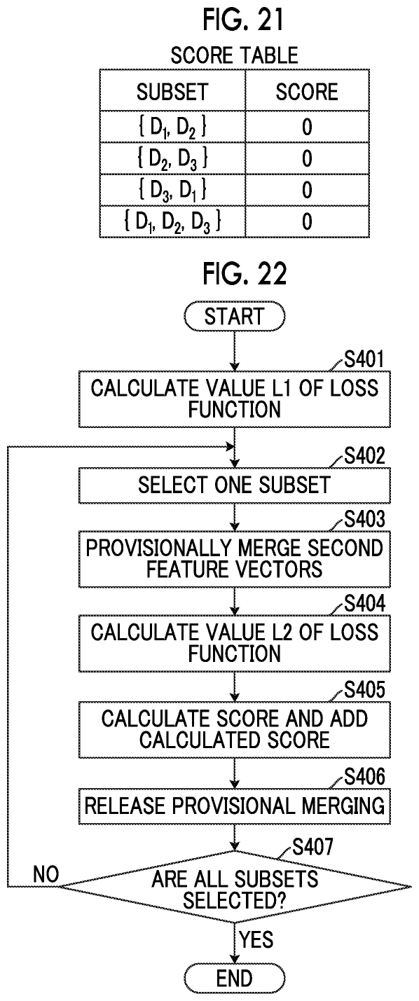

In step S302, the training control unit 340 lists all patterns of subsets including two or more elements of the set S={D₁, D₂, D₃} of the second feature vectors, and creates a score table as illustrated in FIG. 21. In the score table of FIG. 21, for example, a first subset {D₁, D₂} includes the second feature vectors D₁ and D₂. In addition, an initial value of each score in the score table is 0.

In step S303, the training control unit 340 optimizes a weight and a bias of each of the neurons included in the embedding layer 313 and the prediction unit 314 of the machine learning model 310, by using the training data included in the training data set 360.

Specifically, the training control unit 340 optimizes a weight and a bias of each neuron by an error backward propagation method using a loss function L defined according to the following equation based on a cross-entropy error.

$$L = - {\sum }_{n = 1}^{N} log {P}_{i} ( n )$$

Here, the above equation is based on a premise that the correct answer label is given in a form of a one-hot vector. In addition, in the above equation, Pi(n) is a probability that corresponds to a correct answer label of an n-th training data and is output from the output layer 317 of the machine learning model 310, and is any one of P1 or P2. Specifically, in a case where a correct answer label of an n-th training data is “shorter than 7 days”, Pi(n)=P1, and in a case where a correct answer label of an n-th training data is “7 days or longer”, Pi(n)=P2. In addition, N is the total number of the pieces of training data, and for example, N=100.

In step S304, the training control unit 340 calculates a score of each of subsets included in the score table of FIG. 21. Specifically, the training control unit 340 executes score calculation processing illustrated in the flowchart of FIG. 22.

In step S401 of FIG. 22, the training control unit 340 calculates a value of the loss function described above in response to inputs of N pieces of training data to the machine learning model 310. It is assumed that the value of the loss function is L1.

In step S402, the training control unit 340 selects one subset from the score table of FIG. 21. For example, the training control unit 340 selects a subset {D₂, D₃}.

In step S403, the training control unit 340 provisionally merges the second feature vectors included in the subset selected in step S402. Specifically, the training control unit 340 provisionally changes the conversion rule from the first feature vectors to the second feature vectors in the merging layer 312 by rewriting the weights of the matrix W⁽¹⁾ of the merging layer 312.

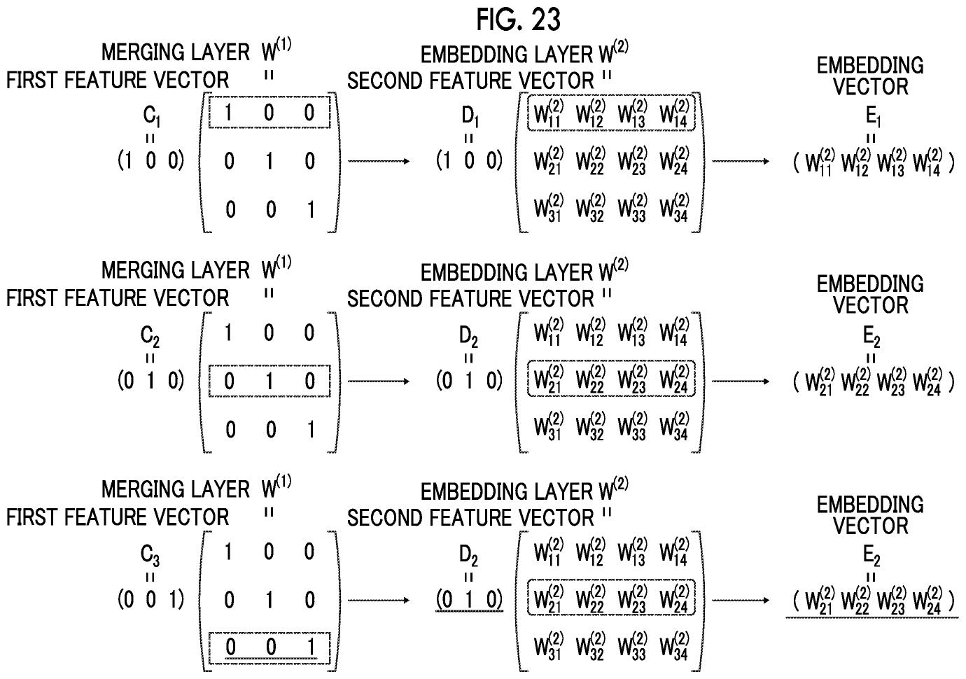

For example, in a case of provisionally merging the second feature vectors D₂ and D₃, as illustrated in FIG. 23, the training control unit 340 provisionally rewrites each element of a third row of the matrix W⁽¹⁾ of the merging layer 312 to (0, 1, 0). Thereby, in a case where the first feature vector C₃=(0, 0, 1) is input to the merging layer 312, the second feature vector D₂=(0, 1, 0) is output from the merging layer 312.

This means that the second feature vectors D₂ and D₃ output from the merging layer 312 are merged by changing the conversion rule from the first feature vectors to the second feature vectors in the merging layer 312.

In a case of provisionally merging the second feature vectors D₂ and D₃, each element of a second row of the matrix W⁽¹⁾ of the merging layer 312 may be provisionally rewritten to (0, 0, 1). In this case, in a case where the first feature vector C₂=(0, 1, 0) is input to the merging layer 312, the second feature vector D₃=(0, 0, 1) is output from the merging layer 312.

In step S404, in a state where the second feature vectors are provisionally merged, the training control unit 340 recalculates a value of the loss function described above in response to re-inputs of N pieces of training data to the machine learning model 310. It is assumed that the value of the loss function is L2.

In step S405, the training control unit 340 calculates a score for the subset including the second feature vectors which are provisionally merged according to the following equation, and adds the calculated score to the score of the subset in the score table of FIG. 21.

Score=L1−L2

Here, in the above equation, L1 is a value of the loss function that is previously calculated in step S401, and L2 is a value of the loss function that is recalculated in step S404.

For example, in a case where the score calculated in a case where the second feature vectors D₂ and D₃ are provisionally merged is 0.7, the training control unit 340 adds 0.7 to the score of the second subset {D₂, D₃} of the score table in FIG. 21.

In step S406, the training control unit 340 releases the merging of the second feature vectors which are provisionally merged. Specifically, the training control unit 340 returns the conversion rule from the first feature vectors to the second feature vectors in the merging layer 312 by rewriting the weights of the matrix W⁽¹⁾ of the merging layer 312.

In step S407, the training control unit 340 determines whether or not all the subsets in the score table of FIG. 21 are selected and processing of step S402 to step S406 described above is executed.

In a case where all the subsets in the score table of FIG. 21 are not selected, the training control unit 340 returns to step S402 and selects an unselected subset.

On the other hand, in a case where all the subsets in the score table of FIG. 21 are selected and processing of step S402 to step S406 is executed, the training control unit 340 proceeds to processing of step S305 in FIG. 20.

In step S305 of FIG. 20, the training control unit 340 determines whether or not the second feature vectors are allowed to be merged. Specifically, the training control unit 340 determines whether or not the number of the second feature vectors which are already merged is smaller than a predetermined fifth threshold value and there is a subset in which the score in the score table is equal to or higher than a predetermined sixth threshold value.

In a case where it is determined in step S305 that the second feature vectors are not allowed to be merged, that is, in a case of NO in step S305, the training control unit 340 proceeds to processing of step S309 to be described later.

On the other hand, in a case where it is determined in step S305 that the second feature vectors are allowed to be merged, that is, in a case of YES in step S305, the training control unit 340 proceeds to the following processing of step S306.

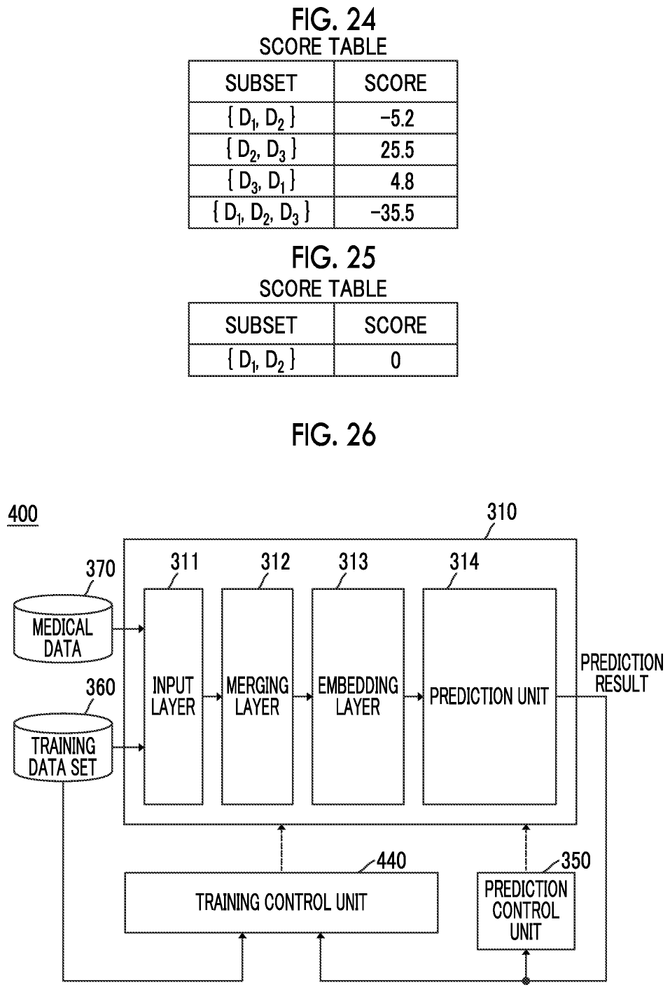

For example, in a case where the fifth threshold value=2, the sixth threshold value=20, and the score table is in a state as illustrated in FIG. 24, it is determined that the second feature vectors D₂ and D₃ included in the subset {D₂, D₃} are allowed to be merged.

In step S306, the training control unit 340 performs merging of the second feature vectors determined as being allowed to be merged in step S305. Specifically, the training control unit 340 changes the conversion rule from the first feature vectors to the second feature vectors in the merging layer 312 by rewriting the weights of the matrix W⁽¹⁾ of the merging layer 312.

In step S307, the training control unit 340 redefines the set S previously defined in step S301. For example, in a case where the second feature vectors D₂ and D₃ are merged in step S306, the set S={D₁, D₂} is redefined.

In step S308, the training control unit 340 recreates the score table that is previously created in step S302. For example, in a case where the set S={D₁, D₂} is redefined in step S307, the score table is as illustrated in FIG. 25.

In step S309, the training control unit 340 determines whether or not processing of step S303 to step S308 is executed a preset number of times. For example, the preset number of times=10000 times.

In a case where processing of step S303 to step S308 is not executed the preset number of times, the training control unit 340 returns to processing of step S303.

On the other hand, in a case where processing of step S303 to step S308 is executed the preset number of times, the training control unit 340 ends the processing of the flowchart of FIG. 20.

In a case where the processing is ended, training of the machine learning model 310 is completed. The second feature vectors that are merged such that the prediction accuracy of the machine learning model 310 is improved are output from the merging layer 312 of the trained machine learning model 310. The embedding layer 313 of the trained machine learning model 310 outputs the embedding vectors that accurately capture the meaning of the merged second feature vectors. The prediction unit 314 of the trained machine learning model 310 outputs a probability of the hospitalization period that is predicted from the medical data of the patient.

As described above, the machine learning model 310 of the prediction server 300 according to the present exemplary embodiment 3 includes the merging layer 312 that converts the first feature vectors into the second feature vectors and outputs the second feature vectors. In a process of training the machine learning model 310, by changing the conversion rule from the first feature vectors to the second feature vectors in the merging layer 312, the training control unit 340 of the prediction server 300 merges the second feature vectors output from the merging layer 312.

Specifically, by using an algorithm in which a score is given based on a value of a loss function used for training the machine learning model 310, the training control unit 340 of the prediction server 300 merges the second feature vectors output from the merging layer 312.

By the above characteristics, the same effect as in the case of reducing the number of dimensions by merging the first feature vectors generated from the medical data of the patient can be obtained. As a result, the prediction accuracy of the machine learning model 310 is improved as compared with a case where first feature vectors are not merged and the number of dimensions is not reduced. The reason why the prediction accuracy is improved by reducing the number of dimensions of the feature vectors is as described above.

The number of the second feature vectors to be merged in the merging layer 312 may be included as the score of the algorithm used in a case of optimizing the conversion rule of the merging layer 312. For example, by increasing the score in proportion to the number of the second feature vectors to be merged, merging of the second feature vectors is more positively performed.

In addition, an initial value of the score of the algorithm is 0 in the score table of FIG. 21. On the other hand, the initial value of the score may be determined based on an edit distance, a distributed representation, related information, or the like of the first feature vectors to be input to the merging layer 312. By providing the initial value in such a method, optimization will proceed faster.

In addition, the algorithm used in a case of changing the conversion rule of the merging layer 312 is not limited to the algorithm described above. As an algorithm used in a case of changing the conversion rule of the merging layer 312, various algorithms including a reinforcement learning algorithm such as REINFORCE, Q-learning, or DQN can be used.

### Exemplary Embodiment 4

Next, a prediction server 400 according to an exemplary embodiment 4 of the present disclosure will be described. Note that, in the following description, components that are the same as or similar to those in the exemplary embodiment 3 are denoted by the same reference numerals and a detailed description of the components will be omitted.

In the present exemplary embodiment 4 and exemplary embodiments 5 and 6 to be described later, in the process of training the machine learning model 310, an operation for making a combination of similar embedding vectors more similar is performed. Thereafter, the combinations of the second feature vectors corresponding to the combinations of the embedding vectors that are significantly similar are merged.

### (Functional Configuration of Prediction Server 400)

FIG. 26 is a diagram illustrating a functional configuration of the prediction server 400 according to the present exemplary embodiment 4. In the prediction server 400, the training control unit 340 included in the exemplary embodiment 3 is replaced with a training control unit 440.

### (Training Control Unit 440)

In a process of training the machine learning model 310 to predict a patient's hospitalization period, by changing the conversion rule from the first feature vectors to the second feature vectors in the merging layer 312, the training control unit 440 merges the second feature vectors output from the merging layer 312.

Specifically, the training control unit 440 introduces a term that makes a combination of the similar embedding vectors more similar, to a loss function used for training the machine learning model 310. Thereby, training of the machine learning model 310 is performed under a constraint that a combination of the similar embedding vectors is made more similar. In addition, the training control unit 440 merges the combinations of the second feature vectors corresponding to the combinations of the embedding vectors that are significantly similar. Thereby, the same effect as in the case of reducing the number of dimensions by merging the first feature vectors generated from the medical data of the patient can be obtained.

### (Operation of Prediction Server 400 in Training of Machine Learning Model 310)

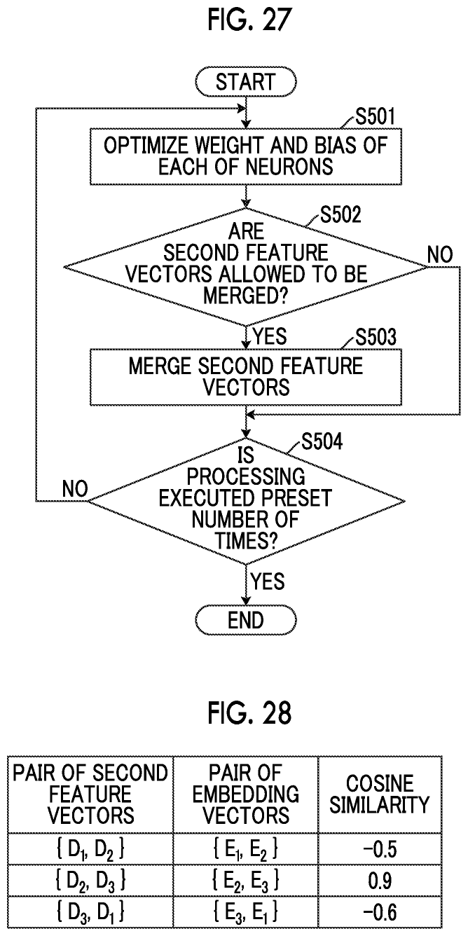

FIG. 27 is a flowchart illustrating training processing of the machine learning model 310 executed by the training control unit 440 of the prediction server 400.

In step S501 of FIG. 27, the training control unit 440 optimizes a weight and a bias of each of the neurons included in the embedding layer 313 and the prediction unit 314 of the machine learning model 310, by using the training data included in the training data set 360.

Specifically, the training control unit 440 optimizes a weight and a bias of each neuron by an error backward propagation method using a loss function L defined according to the following equation.

$$L = - {\sum }_{n = 1}^{N} ( log {P}_{i} ( n ) ) + \frac{γ}{{\sum }_{i \neq j} {σ}_{ij}}$$

Here, in the above equation, Pi(n) is a probability that corresponds to a correct answer label of an n-th training data and is output from the output layer 317 of the machine learning model 310, and is any one of P1 or P2. Specifically, in a case where a correct answer label of an n-th training data is “shorter than 7 days”, Pi(n)=P1, and in a case where a correct answer label of an n-th training data is “7 days or longer”, Pi(n)=P2. In addition, N is the total number of the pieces of training data, and for example, N=100.

Further, in the above equation, γ is a parameter for scale adjustment. Further, σᵢⱼ is a similarity of the combinations of the embedding vectors of which the similarity Sim is equal to or higher than a predetermined threshold value TH, and is defined according to the following equation.

$${σ}_{ij} = \{ \begin{matrix}Sim ( {E}_{i} , {E}_{j} ) & if Sim ( {E}_{i} , {E}_{j} ) \geq TH \\ 0 & if Sim ( {E}_{i} , {E}_{j} ) < TH\end{matrix}$$

$$Sim ( {E}_{i} , {E}_{j} ) = \frac{{E}_{i} \cdot {E}_{j}}{‖ {E}_{i} ‖ ‖ {E}_{j} ‖} + 1$$

In the above equation, the threshold value TH is, for example, 0.8.

In the present exemplary embodiment 4, in an initial state before training of the machine learning model 310, three embedding vectors E₁, E₂, and E₃ are present. Therefore, there are combinations {E₁, E₂}, {E₂, E₃}, and {E₃, E₁} of the three embedding vectors. In this case, σᵢⱼ is a similarity of a combination in which the similarity Sim is equal to or higher than the threshold value TH among the combinations of the three embedding vectors.

As described above, by introducing, to the loss function L, a term that makes a combination of the similar embedding vectors more similar, as training of the machine learning model 310 progresses, the combination of the similar embedding vectors is made more similar.

In step S502, the training control unit 440 determines whether or not the second feature vectors are allowed to be merged. Specifically, the training control unit 440 determines whether or not there is a combination of the second feature vectors corresponding to a combination of the embedding vectors of which the cosine similarity is equal to or higher than a predetermined first similarity. Here, the cosine similarity is defined according to the following equation in which one embedding vector is denoted by A and the other embedding vector is denoted by B.

$$cosine similarity = \frac{A \cdot B}{‖ A ‖ ‖ B ‖}$$

In a case where it is determined in step S502 that the second feature vectors are not allowed to be merged, that is, in a case of NO in step S502, the training control unit 440 proceeds to processing of step S504 to be described later.

On the other hand, in a case where it is determined in step S502 that the second feature vectors are allowed to be merged, that is, in a case of YES in step S502, the training control unit 440 proceeds to the following processing of step S503.

For example, in a case where the first similarity=0.8 and there are a combination of the second feature vectors and a combination of the embedding vectors as illustrated in FIG. 28, it is determined that the second feature vectors D₂ and D₃ having a cosine similarity of 0.9 are allowed to be merged.

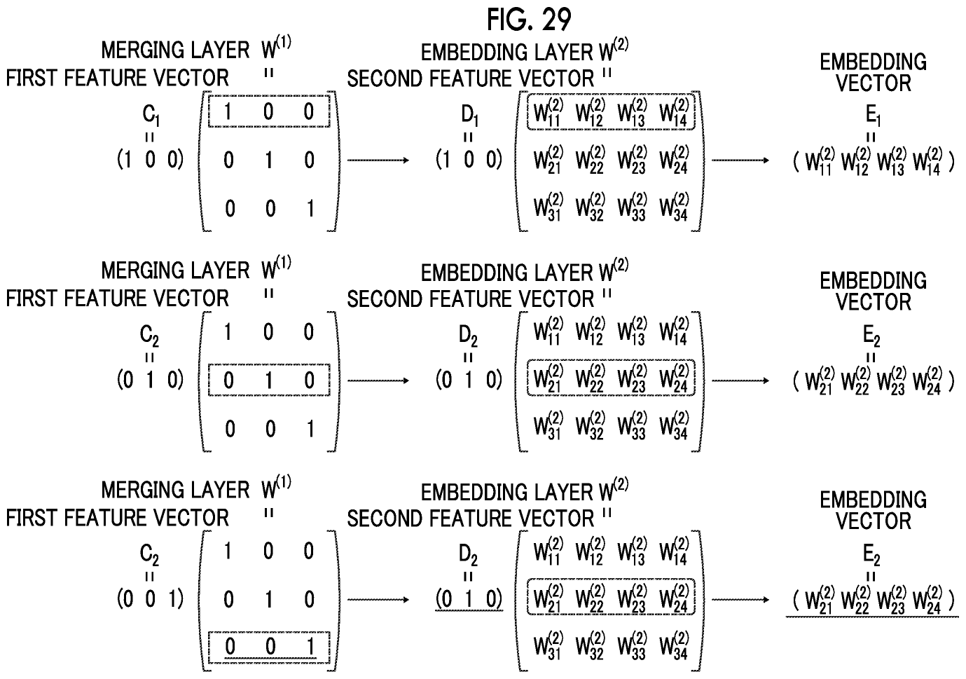

In step S503, the training control unit 440 merges the combination of the second feature vectors determined as being allowed to be merged in step S502. Specifically, as illustrated in FIG. 29, by rewriting a weight of a third row of the matrix W⁽¹⁾ of the merging layer 312, the training control unit 440 merges the second feature vectors D₂ and D₃ output from the merging layer 312.

In step S504, the training control unit 440 determines whether or not processing of step S501 to step S503 is executed a preset number of times. For example, the preset number of times=10000 times.

In a case where processing of step S501 to step S503 is not executed the preset number of times, the training control unit 440 returns to processing of step S501.

On the other hand, in a case where processing of step S501 to step S503 is executed the preset number of times, the training control unit 440 ends the processing of the flowchart of FIG. 27.

In a case where the processing is ended, training of the machine learning model 310 is completed. The second feature vectors that are merged such that the prediction accuracy of the machine learning model 310 is improved are output from the merging layer 312 of the trained machine learning model 310. The embedding layer 313 of the trained machine learning model 310 outputs the embedding vectors that accurately capture the meaning of the merged second feature vectors and have improved similarity. The prediction unit 314 of the trained machine learning model 310 outputs a probability of the hospitalization period that is predicted from the medical data of the patient.

As described above, the training control unit 440 of the prediction server 400 according to the present exemplary embodiment 4 introduces a term that makes a combination of the similar embedding vectors more similar, to the loss function L used for training the machine learning model 310. Thereby, the same effect as in the case of reducing the number of dimensions by merging the first feature vectors generated from the medical data of the patient can be obtained. As a result, the prediction accuracy of the machine learning model 310 is improved as compared with a case where first feature vectors are not merged and the number of dimensions is not reduced.

In the exemplary embodiment 4, as another method of determining whether or not the combination of the second feature vectors is allowed to be merged in step S502 of the flowchart of FIG. 27, as in the exemplary embodiment 2, in a case where the change value of the prediction result of the machine learning model 310 in a case where the combination of the embedding vectors is replaced is lower than the predetermined seventh threshold value, the combination of the second feature vectors corresponding to the combination of the embedding vectors may be specified as the combination of the second feature vectors that are allowed to be merged.

### Exemplary Embodiment 5

Next, a prediction server 500 according to an exemplary embodiment 5 of the present disclosure will be described.

### (Functional Configuration of Prediction Server 500)

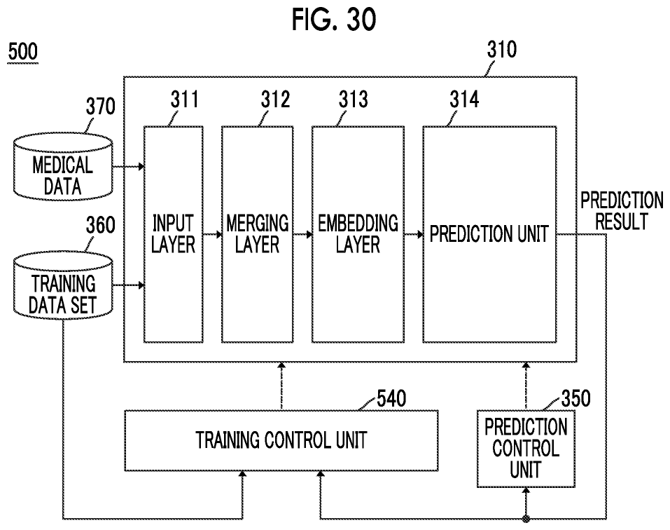

FIG. 30 is a diagram illustrating a functional configuration of the prediction server 500 according to the present exemplary embodiment 5. In the prediction server 500, the training control unit 340 included in the exemplary embodiment 3 is replaced with a training control unit 540.

### (Training Control Unit 540)

In a process of training the machine learning model 310 to predict a patient's hospitalization period, by changing the conversion rule from the first feature vectors to the second feature vectors in the merging layer 312, the training control unit 540 merges the second feature vectors output from the merging layer 312.

Specifically, in the process of training the machine learning model 310, the training control unit 540 swaps the combination of the embedding vectors having a similarity equal to or higher than a predetermined second similarity with a predetermined probability. Thereby, training of the machine learning model 310 is performed under a situation where the combination of the similar embedding vectors is exchanged with a certain probability. In addition, the training control unit 540 merges the combinations of the second feature vectors corresponding to the combinations of the embedding vectors that are significantly similar. Thereby, the same effect as in the case of reducing the number of dimensions by merging the first feature vectors generated from the medical data of the patient can be obtained.

### (Operation of Prediction Server 500 in Training of Machine Learning Model 310)

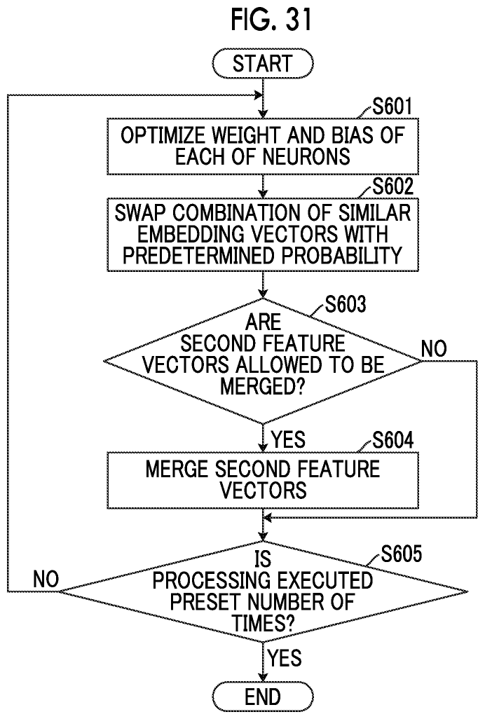

FIG. 31 is a flowchart illustrating training processing of the machine learning model 310 executed by the training control unit 540 of the prediction server 500.

In step S601 of FIG. 31, the training control unit 540 optimizes a weight and a bias of each of the neurons included in the embedding layer 313 and the prediction unit 314 of the machine learning model 310, by using the training data included in the training data set 360.

In step S602, the training control unit 540 swaps the combination of the embedding vectors having a similarity equal to or higher than a predetermined second similarity with a predetermined probability. As the similarity, the cosine similarity described above can be used. For example, the predetermined second similarity is 0.6, and the predetermined probability is ½.

In the present exemplary embodiment 5, in an initial state before training of the machine learning model 310, combinations of three embedding vectors {E₁, E₂}, {E₂, E₃}, and {E₃, E₁} are present. In a process of training the machine learning model 310, in a case where there is a combination having a cosine similarity equal to or higher than 0.6 among these three combinations, the combination is replaced with a probability of ½.

As described above, in the process of training the machine learning model 310, by exchanging the combination of the similar embedding vectors with a certain probability, as training of the machine learning model 310 progresses, the combination of the similar embedding vectors is made more similar.

Specifically, as the training of the machine learning model 310 progresses, the combination of the similar embedding vectors is replaced with a certain probability. In this case, for the replaced combination, embedding vectors different from the originally optimized embedding vectors are input, and as a result, a loss is increased. On the other hand, in a case of making a distance of the similar embedding vectors short, even in a case where the combination of the embedding vectors is replaced, embedding vectors that are not different from the originally optimized embedding vectors are input, and thus a loss is reduced. Since the machine learning model 310 is trained by using the combination of the replaced embedding vectors, the combination of the similar embedding vectors is made more similar.

Subsequent processing of step S603 to step S605 is the same as the processing of step S502 to step S504 of the exemplary embodiment 4 described above.

As described above, in the process of training the machine learning model 310, the training control unit 540 of the prediction server 500 according to the exemplary embodiment 5 swaps the combination of the embedding vectors having a similarity equal to or higher than a predetermined second similarity with a predetermined probability. Thereby, the same effect as in the case of reducing the number of dimensions by merging the first feature vectors generated from the medical data of the patient can be obtained. As a result, the prediction accuracy of the machine learning model 310 is improved as compared with a case where first feature vectors are not merged and the number of dimensions is not reduced.

### Exemplary Embodiment 6

Next, a prediction server 600 according to an exemplary embodiment 6 of the present disclosure will be described.

### (Functional Configuration of Prediction Server 600)

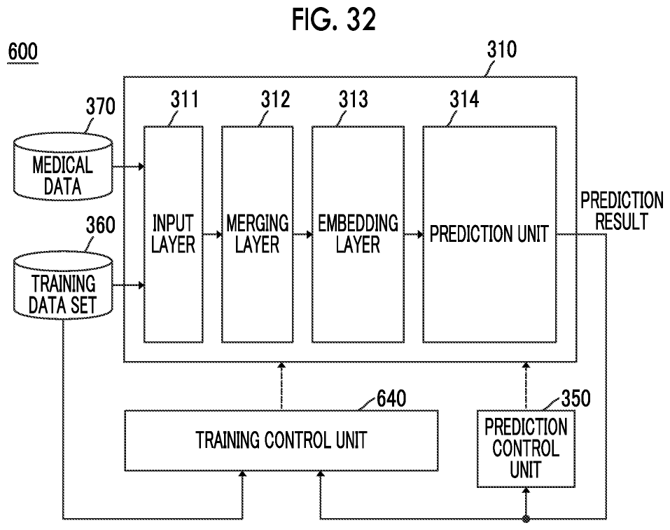

FIG. 32 is a diagram illustrating a functional configuration of the prediction server 600 according to the present exemplary embodiment 6. In the prediction server 600, the training control unit 340 included in the exemplary embodiment 3 is replaced with a training control unit 640.

### (Training Control Unit 640)

In a process of training the machine learning model 310 to predict a patient's hospitalization period, by changing the conversion rule from the first feature vectors to the second feature vectors in the merging layer 312, the training control unit 640 merges the second feature vectors output from the merging layer 312.

Specifically, in the process of training the machine learning model 310, the training control unit 640 adds a correction value for making the combination of the embedding vectors more similar, to at least one of the combinations of the embedding vectors having a similarity equal to or higher than a predetermined third similarity.

Specifically, in a case where one of the combinations of the embedding vectors is A and the other of the combinations is B, a correction value is added to one embedding vector A according to the following equation.

A→A+γB

Here, in the above equation, γ is a predetermined coefficient and 0<γ<1.

By the operation described above, the machine learning model 310 is trained under a situation where disturbance is applied such that the combination of the similar embedding vectors is made more similar. In addition, the training control unit 640 merges the combinations of the second feature vectors corresponding to the combinations of the embedding vectors that are significantly similar. Thereby, the same effect as in the case of reducing the number of dimensions by merging the first feature vectors generated from the medical data of the patient can be obtained.

### (Operation of Prediction Server 600 in Training of Machine Learning Model 310)

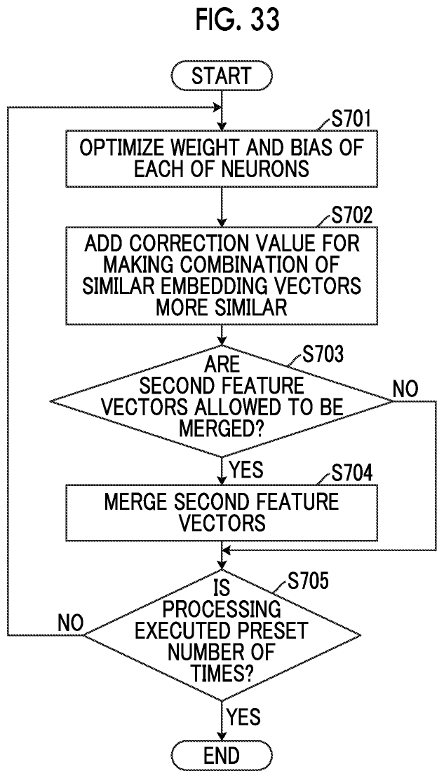

FIG. 33 is a flowchart illustrating training processing of the machine learning model 310 executed by the training control unit 640 of the prediction server 600.

In step S701 of FIG. 33, the training control unit 640 optimizes a weight and a bias of each of the neurons included in the embedding layer 313 and the prediction unit 314 of the machine learning model 310, by using the training data included in the training data set 360.

In step S702, the training control unit 640 adds a correction value for making the combination of the embedding vectors more similar, to at least one of the combinations of the embedding vectors having a similarity equal to or higher than a predetermined third similarity. Here, a cosine similarity is also used as the similarity. For example, the predetermined third similarity is 0.6.

As described above, in the process of training the machine learning model 310, by adding disturbance that makes a combination of the similar embedding vectors more similar, as training of the machine learning model 310 progresses, the combination of the similar embedding vectors is made more similar.

Subsequent processing of step S703 to step S705 is the same as the processing of step S502 to step S504 of the exemplary embodiment 4 described above.

As described above, in the process of training the machine learning model 310, the training control unit 640 of the prediction server 600 according to the present exemplary embodiment 6 adds a correction value for making the combination of the embedding vectors more similar, to at least one of the combinations of the embedding vectors having a similarity equal to or higher than a predetermined third similarity. Thereby, the same effect as in the case of reducing the number of dimensions by merging the first feature vectors generated from the medical data of the patient can be obtained. As a result, the prediction accuracy of the machine learning model 310 is improved as compared with a case where first feature vectors are not merged and the number of dimensions is not reduced.

In the exemplary embodiment 2, the specifying unit 220 specifies, in the patterns illustrated in FIG. 15, as the combination of the feature vectors that are allowed to be merged, a combination of the feature vectors in which the change value of the prediction result is lower than a predetermined fourth threshold value. On the other hand, the present invention is not limited thereto. As a method for showing that a difference between the prediction result of the provisional model 280 in a case where the feature vectors are replaced and the prediction result of the provisional model 280 in a case where the feature vectors are not replaced is small, for example, a combination of the feature vectors in which the similarity of the prediction result is equal to or higher than a predetermined fourth similarity instead of the change value of the prediction result may be specified as a combination of feature vectors that are allowed to be merged. More specifically, a similarity between a prediction result vector obtained by treating the prediction result as a vector and converting the prediction result into a vector in a case of inputting the selected combination of the feature vectors to the provisional model 280 without replacing the combination and a prediction result vector obtained by converting the prediction result into a vector in a case of inputting the selected combination of the feature vectors to the provisional model 280 while replacing the combination is derived. In a case where the similarity between the prediction result vectors is equal to or higher than a fourth similarity, the combination of the feature vectors is specified as a combination of the feature vectors that are allowed to be merged. The similarity between the prediction result vectors is indicated by, for example, a cosine similarity.

Further, as in the exemplary embodiment 6, in a case where a similarity of a prediction result of the machine learning model 310 in a case where the combination of the embedding vectors is swapped is equal to or higher than a predetermined fifth threshold value, the combination of the second feature vectors corresponding to the combination of the embedding vectors may be specified as a combination of the feature vectors that are allowed to be merged. The similarity of the prediction result refers to a similarity between a prediction result vector obtained by converting the prediction result output from the machine learning model 310 into a vector without replacing the combination of the embedding vectors and a prediction result vector obtained by converting the prediction result output from the machine learning model 310 into a vector while replacing the combination of the embedding vectors. The similarity between the prediction result vectors is indicated by, for example, a cosine similarity or the like.

Further, in the exemplary embodiments, a case where a pair of two items such as “age group” and “gender” are used as feature vectors that are allowed to be merged. On the other hand, the present invention is not limited thereto. Three or more items such as “age group”, “gender”, and “medical department” may be specified as a combination of feature vectors that are allowed to be merged.

Further, in the exemplary embodiments, for example, the following various processors can be used as a hardware structure of processing units performing various processes, such as the specifying unit, the rule generation unit, the merging unit, the model generation unit, the training control unit, and the prediction control unit. Various processors include a programmable logic device (PLD) that is capable of changing a circuit configuration after manufacturing, such as a field-programmable gate array (FPGA), and a dedicated electric circuit that is a processor having a circuit configuration dedicatedly designed for executing specific processing, such as an application specific integrated circuit (ASIC), in addition to a CPU that is a general-purpose processor configured to execute software (program) to function as various processing units.

The various pieces of processing may be executed by one of the various processors or a combination of two or more processors of the same type or different types (for example, a plurality of FPGAs and a combination of CPU and FPGA). Further, the plurality of processing units may be configured by one processor. As an example where a plurality of processing units are configured with one processor, like system-on-chip (SOC), there is a form in which a processor that realizes all functions of a system including a plurality of processing units into one integrated circuit (IC) chip is used.

In this manner, the various processing units are configured by using one or more various processors as a hardware structure.

In addition, as the hardware structure of various processors, more specifically, an electric circuit (circuitry) in which circuit elements such as semiconductor elements are combined can be used.

Further, the technique of the present disclosure is applied to not only an operation program of a data merging rule generation device, an operation program of a learning device, and an operation program of an imaging device but also a non-transitory computer readable storage medium (a USB memory, a digital versatile disc (DVD)-read only memory (ROM), or the like) storing the operation program of the imaging device.

The entire disclosure of Japanese Patent Application No. 2021-137517 filed on Aug. 25, 2021 is incorporated into the present specification by reference.

All literatures, patent applications, and technical standards described in the present specification are incorporated in the present specification by reference to the same extent as in a case where the individual literatures, patent applications, and technical standards are specifically and individually stated to be incorporated by reference.

What is claimed is:

1. A device for generating a data merging rule for a machine learning model, the device comprising:
a processor; and
a memory connected to or built in the processor, the processor being configured to:
specifying processing of specifying a combination of feature vectors that are included in a data set including a correct answer label and are allowed to be merged; and
rule generation processing of generating a merging rule of the feature vectors based on a combination of the feature vectors that are allowed to be merged.

2. The device for generating a data merging rule according to claim 1, wherein, in the specifying processing, the processor is configured to create a frequency distribution of a correct answer label for each of the feature vectors included in the data set, and specify a combination of the feature vectors in which a similarity in the frequency distribution of the correct answer label is equal to or higher than a predetermined first threshold value, as the combination of the feature vectors that are allowed to be merged.

3. The device for generating a data merging rule according to claim 2, wherein, in the specifying processing, the processor is configured to further create, for a combination specified as the combination of the feature vectors that are allowed to be merged, a frequency distribution in consideration of a combination of a plurality of items, and exclude the specified combination from the combinations of the feature vectors that are allowed to be merged in a case where a similarity in the frequency distribution in consideration of the combination of the items is lower than a predetermined second threshold value.

4. The device for generating a data merging rule according to claim 1, wherein, in the specifying processing, the processor is configured to create, for each of the feature vectors included in the data set, a frequency distribution of a correct answer label in consideration of a combination of a plurality of items, and specify a combination of the feature vectors in which a similarity in the frequency distribution of the correct answer label is equal to or higher than a predetermined seventh threshold value, as the combination of the feature vectors that are allowed to be merged.

5. The device for generating a data merging rule according to claim 1, wherein, in the rule generation processing, the processor is configured to end generation of the merging rule in a case where the number of combinations of the feature vectors that are included in the merging rule and are allowed to be merged is equal to or larger than a predetermined third threshold value.

6. The device for generating a data merging rule according to claim 1, wherein, in the specifying processing, the processor is configured to:
generate a provisional model in which the feature vectors included in the data set are used as inputs and train the provisional model; and
select a combination of the feature vectors from the data set, and specify, as the combination of the feature vectors that are allowed to be merged, the selected combination of the feature vectors in a case where a change value of a prediction result of the provisional model in a case where the selected combination of the feature vectors is swapped is lower than a predetermined fourth threshold value.

7. The device for generating a data merging rule according to claim 1, wherein, in the specifying processing, the processor is configured to:
generate a provisional model in which the feature vectors included in the data set are used as inputs and train the provisional model; and
select a combination of the feature vectors from the data set, and specify, as the combination of the feature vectors that are allowed to be merged, the selected combination of the feature vectors in a case where a similarity in a prediction result of the provisional model in a case where the selected combination of the feature vectors is swapped is equal to or higher than a predetermined fourth similarity.

8. The device for generating a data merging rule according to claim 1, wherein, in the specifying processing, candidates of the feature vectors that are allowed to be merged are determined based on at least one of an edit distance, a distribution representation, or related information of the feature vectors.

9. The device for generating a data merging rule according to claim 1, wherein the processor is further configured to:
display processing of displaying the combination of the feature vectors that are allowed to be merged on a display unit; and
reception processing of receiving, from a user, whether or not to merge the combination of the feature vectors that are allowed to be merged.

10. A learning device that trains a machine learning model by using a training data set obtained by performing merging according to a merging rule generated by the device for generating a data merging rule according to claim 1.

11. A prediction device that causes a machine learning model to perform prediction by using, as an input, data obtained by performing merging according to the merging rule generated by the device for generating a data merging rule according to claim 1.

12. An operation method for a device for generating a data merging rule for a machine learning model, the method comprising:
a step of specifying a combination of feature vectors that are included in a data set including a correct answer label and are allowed to be merged; and
a step of generating a merging rule of the feature vectors based on a combination of the feature vectors that are allowed to be merged.

13. A non-transitory computer readable medium storing a program that generates a data merging rule for a machine learning model, the program causing a computer to execute a process comprising:
a step of specifying a combination of feature vectors that are included in a data set including a correct answer label and are allowed to be merged; and
a step of generating a merging rule of the feature vectors based on a combination of the feature vectors that are allowed to be merged.

14. A learning device for a machine learning model, the device comprising:
a processor; and
a memory connected to or built in the processor,
wherein the machine learning model includes a merging layer that converts first feature vectors into second feature vectors and outputs the second feature vectors, and
the processor being configured to:
execute training processing of training the machine learning model in response to an input of the second feature vector; and
merge, in the training processing, the second feature vectors output from the merging layer by changing a conversion rule from the first feature vectors to the second feature vectors in the merging layer.

15. The learning device according to claim 14, wherein the processor is configured to, in the training processing, change the conversion rule in the merging layer by using an algorithm in which a score is given based on a value of a loss function used for training the machine learning model.

16. The learning device according to claim 15, wherein the score of the algorithm includes the number of the second feature vectors to be merged in the merging layer.

17. The learning device according to claim 15, wherein an initial value of the score of the algorithm is determined based on at least one of an edit distance, a distribution representation, or related information of the first feature vectors which are input to the merging layer.

18. The learning device according to claim 14, wherein:
the machine learning model further includes an embedding layer that outputs embedding vectors corresponding to the second feature vectors, and
the processor is configured to, in the training processing, make a combination of the similar embedding vectors more similar.

19. The learning device according to claim 18, wherein the processor is configured to, in the training processing, introduce a term that makes the combination of the similar embedding vectors more similar, to a loss function used for training the machine learning model.

20. The learning device according to claim 18, wherein the processor is configured to, in the training processing, swap a combination of the embedding vectors having a similarity equal to or higher than a predetermined second similarity with a predetermined probability.

21. The learning device according to claim 18, wherein the processor is configured to, in the training processing, add a correction value for making a combination of the embedding vectors more similar, to at least one of combinations of the embedding vectors having a similarity equal to or higher than a predetermined third similarity.

22. The learning device according to claim 18, wherein the processor is configured to, in the training processing, merge combinations of the second feature vectors that correspond to combinations of the embedding vectors having a similarity equal to or higher than a predetermined first similarity.

23. The learning device according to claim 18, wherein the processor is configured to, in the training processing, merge combinations of the second feature vectors that correspond to combinations of the embedding vectors in a case where a change value of a prediction result of the machine learning model in a case where the combination of the embedding vectors is swapped is lower than a predetermined seventh threshold value.

24. The learning device according to claim 18, wherein the processor is configured to, in the training processing, merge combinations of the second feature vectors that correspond to combinations of the embedding vectors in a case where a similarity of a prediction result of the machine learning model in a case where the combination of the embedding vectors is swapped is equal to or higher than a predetermined fifth threshold value.

25. An operation method for a learning device for a machine learning model including a merging layer that converts first feature vectors into second feature vectors and outputs the second feature vectors, the method comprising:
a step of training the machine learning model by using the second feature vectors,
wherein the step of training the machine learning model includes a step of merging the second feature vectors output from the merging layer by changing a conversion rule from the first feature vectors to the second feature vectors in the merging layer.

26. A non-transitory computer readable medium storing a program for training a machine learning model including a merging layer that converts first feature vectors into second feature vectors and outputs the second feature vectors, the program causing a computer to execute a process comprising:
a step of training the machine learning model by using the second feature vectors,
wherein the step of training the machine learning model includes a step of merging the second feature vectors output from the merging layer by changing a conversion rule from the first feature vectors to the second feature vectors in the merging layer.
